(19) United States
(12) Patent Application Publication
(10) Pub. No.: US 2026/0197055 A1
(43) Pub. Date: Jul. 9, 2026

(54) TWO-LEVEL RECONFIGURABLE INTELLIGENT SURFACE CHANNEL STATE INFORMATION

(71) Applicant: InterDigital Patent Holdings, Inc., Wilmington, DE (US)

(72) Inventors: Patrick Svedman, Stockholm (SE); Deepa Gurmukhdas Jagyasi, London (GB); Kyle Jung-Lin Pan, Saint James, NY (US); Allan Yingming Tsai, Boonton, NJ (US); Pascal Adjakple, Great Neck, NY (US); Ravikumar Pragada, Warrington, PA (US); Guodong Zhang, Woodbury, NY (US); Arman Shojaeifard, London (GB)

(73) Assignee: InterDigital Patent Holdings, Inc., Wilmington, DE (US)

(21) Appl. No.: 19/136,019

(22) PCT Filed: Dec. 5, 2023
(86) PCT No.: PCT/US2023/082476

§ 371 Date: Jun. 5, 2025

Related U.S. Application Data
(60) Provisional application No. 63/430,510, filed on Dec. 6, 2022.

(51) Int. Cl. H04B 7/06; H04B 7/04

(52) U.S. Cl. CPC H04B 7/0626; H04B 7/04013

(57) ABSTRACT

Systems, methods, and instrumentalities may be configured for two-level reconfigurable intelligent surface (RIS) channel state information (CSI). A wireless transmit/receive unit may receive a first set of symbols. The WTRU may determine a first RIS CSI based on the first set of symbols, a first RIS CSI estimation matrix, and a first RIS CSI quantization format. The first RIS CSI quantization format may use a uniform distribution of phase quantization points. The WTRU may transmit the first RIS CSI. The WTRU may receive a second set of symbols. The WTRU may determine a second RIS CSI based on the second set of symbols, a second RIS CSI estimation matrix, and a second RIS CSI quantization format. The second RIS CSI quantization format may use a non-uniform distribution of phase quantization points. The WTRU may transmit the second RIS CSI.

### CROSS REFERENCE

This application claims the benefit of provisional U.S. patent application No. 63/430,510, filed Dec. 6, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities may be configured for two-level reconfigurable intelligent surface (RIS) channel state information (CSI). A wireless transmit/receive unit may receive a first set of symbols. The WTRU may determine a first RIS CSI based on the first set of symbols, a first RIS CSI estimation matrix, and a first RIS CSI quantization format. The first RIS CSI quantization format may use a uniform distribution of phase quantization points. The WTRU may transmit the first RIS CSI. The WTRU may receive a second set of symbols. The WTRU may determine a second RIS CSI based on the second set of symbols, a second RIS CSI estimation matrix, and a second RIS CSI quantization format. The second RIS CSI quantization format may use a non-uniform distribution of phase quantization points. The WTRU may transmit the second RIS CSI.

The WTRU may receive configuration information. The configuration information may indicate a first set of trigger values. The determination of the first RIS CSI may be performed based on one or more of the first set of trigger values being satisfied. The configuration information may indicate a second set of trigger values. The determination of the second RIS CSI may be performed based on one or more of the second set of trigger values being satisfied.

The first set of trigger values may be indicated in downlink control information (DCI) in a physical downlink control channel (PDCCH). The second set of trigger values may be indicated in downlink control information (DCI) in a physical downlink control channel (PDCCH). The non-uniform distribution of phase quantization points may include a highest density around a phase zero.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a RIS-aided system;

FIG. 3 illustrates an example of a distribution of RIS elements into sub-surfaces;

FIG. 4 illustrates an example of sub-surfaces;

FIG. 5 illustrates an example RIS CSI procedure;

FIG. 6 illustrates an example signaling diagram;

FIG. 7 illustrates an example WTRU procedure;

FIG. 8 illustrates an example RIS procedure;

FIG. 9 illustrates an example of a two-level CSI procedure;

FIG. 10 illustrates an example of a two-level CSI procedure;

FIG. 11 illustrates an example of uniform and non-uniform phase shift quantization;

FIG. 12 illustrates an example of uniform and non-uniform phase shift quantization;

FIG. 13 illustrates an example of a WTRU procedure;

FIG. 14 illustrates an example of a WTRU procedure;

FIG. 15 illustrates an example of a RIS procedure;

FIG. 16 illustrates an example of a RIS procedure;

FIG. 17 illustrates an example hierarchy of RIS state spaces; and

FIG. 18 illustrates an example hierarchy of RIS state spaces.

### DETAILED DESCRIPTION

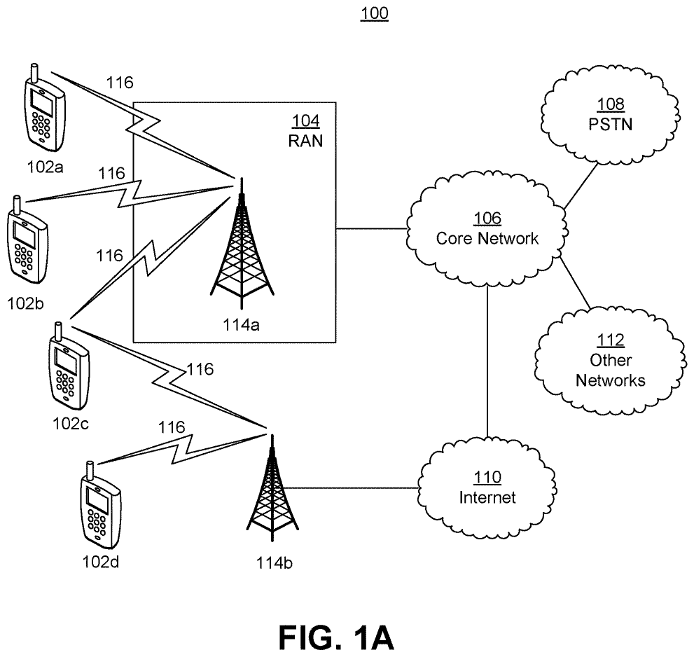

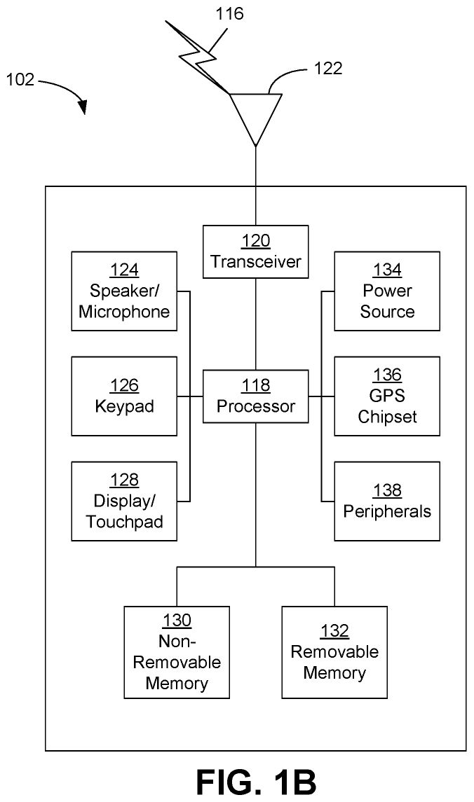

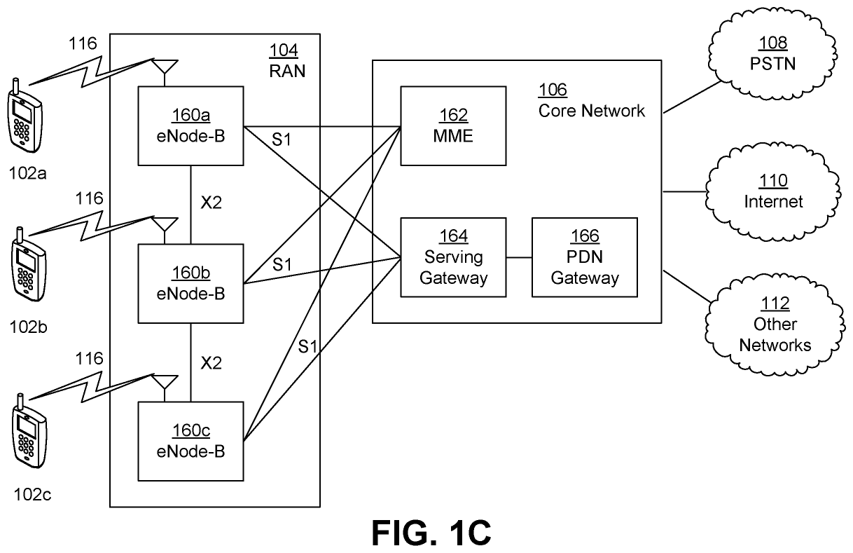

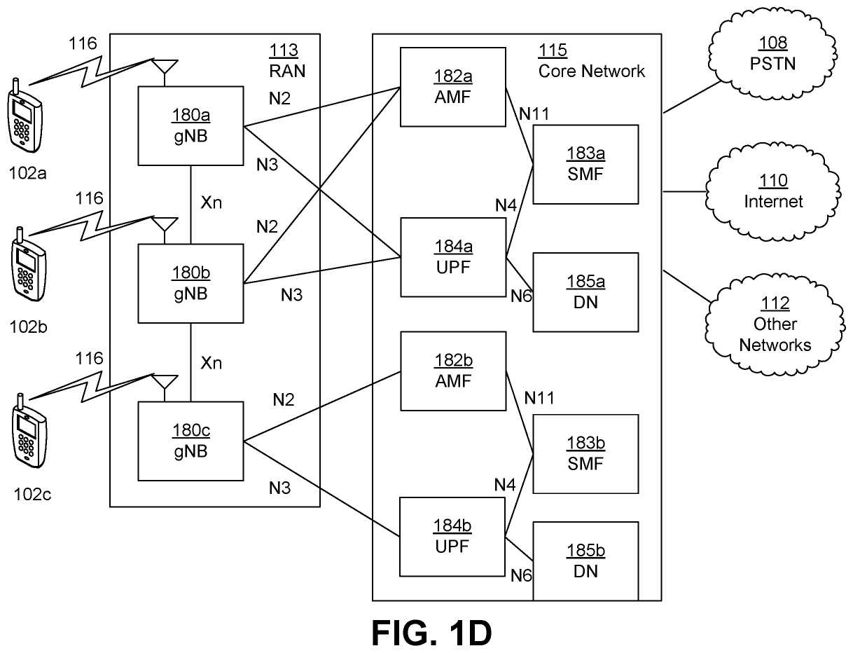

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (18-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize ON support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the ON 115 via an N11 interface. The SMF 183a, 183b may also be connected to a UPF 184a, 184b in the ON 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

CSI acquisition is a function in wireless communication systems that may be used to adapt the transmission scheme. The CSI acquisition may be based on the WTRU-reporting of CSI that is based on measurement of reference signals, e.g., CSI-RS. With the introduction of a reconfigurable intelligent surface (RIS) in the radio environment, the CSI procedure may be extended to incorporate the adaptation of the RIS state in the presence of additional links between a WTRU-RIS and BS-RIS.

Methods may be described herein for RIS CSI acquisition based on the use of a prior RIS state. By using a RIS state (e.g., the prior RIS state) that was previously found to be good for a WTRU, a RIS CSI procedure with reduced overhead may be developed that (e.g., incrementally) adjusts the RIS state for the WTRU. A two-level RIS CSI procedure may be devised, in which a level 1 RIS CSI (e.g., a first RIS CSI) procedure does not include a prior RIS state, while a level 2 RIS CSI (e.g., a second RIS CSI) procedure includes a prior RIS state (e.g., determination of the level 2 RIS CSI may be based on the prior RIS state). The level 1 RIS CSI report from a WTRU may provide an accurate recommended RIS state with high overhead, while a level 2 RIS CSI report may provide a RIS state adjustment based on the prior RIS state with low overhead. (e.g., the RIS state adjustment may be based on the second RIS CSI, and the second RIS CSI may be based on the prior RIS state).

A reconfigurable intelligent surface (RIS) may be included in a wireless network, for example, due to its capability of configuring a wireless propagation environment. An RIS may include a planar surface comprising a (e.g., large) number of sub-wavelength sized scattering elements (e.g., also referred to as RIS elements herein). An RIS element may alter (e.g., dynamically alter) the electromagnetic properties (e.g., phase and/or amplitude) of an impinging signal with an electronic RIS controller. For example, by modifying (e.g., optimizing) the state of RIS elements, an impinging signal may be directed towards a (e.g., desired) receiver while improving communication performance, e.g., higher spectral efficiency, enhanced coverage, etc. Along with providing a (e.g., improved) wireless communication environment, RIS elements may support applications such as joint communication, sensing, and/or wireless power transfer. RIS elements may support features such as reflection, refraction, focusing, collimation, polarization, etc. An RIS may be classified as passive, semi-active, or active. A passive RIS may shift the phase of an impinging signals and may include multiple passive elements. A semi-active and/or active RIS may offer phase shift and/or amplification gains. A semi-active RIS may include a number of active elements (e.g., a mixture of active and passive elements), while an active RIS may include (e.g., all) active elements (e.g., only active elements). Active RIS elements may provide sensing capabilities (e.g., may be referred to as autonomous RIS). As a RIS may be considered a network node, RIS-aided communication may include at least three nodes, e.g., a base station (BS), a WTRU, and a RIS. A communication path may be established to involve a RIS (e.g., such as a BS-RIS-WTRU path) along with a BS-WTRU communication path. Communication tasks including initial access, beamforming, control signaling, channel acquisition, CSI reporting, etc., may be updated to enable a RIS-aided communication path and/or to support the introduction of a RIS into a network. For example, channel acquisition and/or CSI reporting may be adapted in a RIS-aided communication scenario.

The term RIS may denote a RIS, a RIS and a RIS controller, or a RIS controller. A base station may communicate with a RIS, e.g., using an air interface, to provide the RIS with control information.

An RIS system may include at least one RIS element. An RIS system may include multiple RIS elements of an RIS (e.g., of a single RIS). An RIS system may be described herein with respect to a downlink (DL), and the same or a similar model may be applicable to an uplink (UL).

A single-antenna WTRU and a narrowband system (e.g., a subcarrier of an OFDM system) may be used in the examples provided herein. Examples may include a multi-antenna WTRU such as a WTRU that may combine multiple received signals into a single received signal based on receiver processing (e.g., using analog, digital, or hybrid beamforming or combining techniques). In examples, such receiver processing may be included in a radio channel.

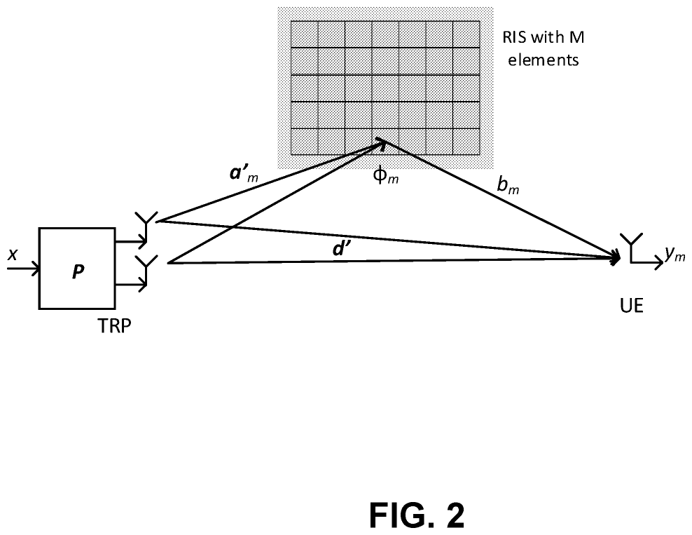

An RIS system (e.g., a RIS system model) may include a (e.g., one) RIS element of a RIS (e.g., one of M RIS elements of the RIS), as illustrated in FIG. 2. An example of an equivalent baseband received complex-valued scalar signal yₘ at a WTRU may be given by Equation 1.

$${y}_{m} = ( {b}_{m} {a}_{m}^{′} {ϕ}_{m} + {d}^{′} ) Px + z = ( {c}_{m}^{′} {ϕ}_{m} + {d}^{′} ) Px + z \qquad ( 1 )$$

wherein x may represent a complex-valued scalar symbol such as a known reference (pilot) symbol, P may represent a complex-valued precoding vector of dimension N_{T}×1 (e.g., N_{T} may be the number of transmit antennas or antenna ports, for example, at a network-side transmission reception point (TRP)), d′=[d′₀ . . . d′_{N}_{_{T}}₋₁] may represent a complex-valued channel between the TRP and the WTRU (e.g., excluding propagation paths via a RIS of dimension 1×N_{T}), a′ₘ may represent a complex-valued vector channel between the TRP and the RIS element of dimension

$$1 \times {N}_{T} , {c}_{m}^{′} = {b}_{m} {a}_{m}^{′}$$

may represent a cascaded complex-valued vector channel between the TRP, RIS element m, and the WTRU, of dimension 1×N_{T}, φₘ=αₘe^{jβ}^{ₘ} may represent a complex-valued scalar RIS element factor of RIS element m, with m=1, . . . , M, bₘ may represent a complex-valued scalar channel between the RIS element and the WTRU, and z may represent additive noise and/or interference.

In a passive RIS, factor φₘ may have a fixed amplitude, e.g., a unit amplitude (|φₘ|=αₘ1). In an active or hybrid RIS, the amplitude αₘ may be variable and/or controllable. The maximum amplification may be limited, e.g., αₘ≤αₘₐₓ for m. In examples, e.g., for a passive RIS, a RIS element may be turned off (e.g., φₘ=0 or φₘ≈0). An RIS element may be in a certain state (φₘ) at a time and may be assumed to be applicable to one or more (e.g., all) sub-carriers within a certain bandwidth.

The terms reference signal (RS) and pilot may be used interchangeably herein. In OFDM, an RS/pilot may include multiple (e.g., known) reference/pilot symbols (e.g., an RS/pilot may include one or more symbols, such as known symbols). The reference/pilot symbols may be mapped to different sub-carriers and/or OFDM symbols.

The example shown in FIG. 2 may be simplified, for example, by including TRP precoding P into the TRP-to-RIS channel. Equation 2 below may be applicable in such a scenario:

$${y}_{m} = ( {b}_{m} {α}_{m} {ϕ}_{m} + d ) x + z = ( {c}_{m} {ϕ}_{m} + d ) x + z \qquad ( 2 )$$

wherein d=d′P may represent a complex valued scalar effective direct TRP-to-RIS channel (e.g., including TRP precoding), aₘ=a′ₘP may represent a complex-valued scalar channel between the TRP and the RIS element, cₘ=bₘaₘ my represent a cascaded complex-valued scalar channel from the TRP to an m:th RIS element to the WTRU.

An RIS system (e.g., a RIS system model) may include multiple RIS elements of a RIS (e.g., all M RIS elements of the RIS). Such a system may be established, for example, by including signals corresponding to the RIS elements (e.g., M RIS elements) of the RIS (cₘφₘs) in the system, e.g., according to Equation 3 below:

$$y = ( ( a ⊙ b ) Φ + d ) x + z = ( c Φ + d ) x + z \qquad ( 3 )$$

wherein a may represent a complex-valued vector channel between the TRP and the RIS, of dimension 1×M (e.g., M may be the number of RIS elements), b may represent a complex-valued vector channel between a RIS and the WTRU (e.g., of dimension 1×M), c=a⊙b=b⊙a may represent an element-wise (e.g., Hadamard) product of a and b, and φ may represent a complex-valued vector of dimension M×1 containing the M RIS element factors φₘ. φ may correspond to a RIS state.

An RIS state may correspond to an M-tuple of RIS element factors (e.g., a set of values of RIS element factors of a RIS). An RIS state may correspond to an S-tuple of RIS sub-surface factors (e.g., sub-surfaces may be disclosed herein), e.g., a set of values of S sub-surfaces factors of a RIS. An RIS state with S RIS sub-surface factors may be mapped to a RIS state with M RIS element factors by setting the RIS element factors that belong to a sub-surface to the corresponding sub-surface factor. An R/S configuration may denote a RIS state. An RIS state and a RIS configuration may be used interchangeably herein.

In examples (e.g., with rectangular RIS), M; may denote the number of RIS elements in a first direction (e.g., horizontal), My may denote the number of RIS elements in a second direction (e.g., vertical), and M may be equal to Mₕ*Mᵥ.

In the presence of an RIS in a communication network, two paths may exist for a receiver node, e.g., a RIS-aided path (e.g., a BS-RIS-WTRU path) and a direct path (e.g., a BS-WTRU path). The RIS-aided path may include a path involving the RIS, The direct path may include signals (e.g., superimposed signals) from multiple (e.g., all) reflected paths or a combined signal (e.g., in case of multi-TRP transmission schemes). The direct path may exclude a path involving the RIS. Channel properties may be controlled by introducing phase and/or amplification gains to an impinging signal on a RIS surface. Channel estimation may be performed in a RIS-aided system (e.g., on a direct and/or RIS-aided path), for example, to improve communication performance.

Channel estimation techniques may include cascaded channel estimation and separated channel estimation. In cascaded channel estimation, an overall effective channel (e.g., represented by

$${b}_{m} {a}_{m}^{′} {ϕ}_{m}$$

as shown in FIG. 2) may be respectively estimated at a WTRU and/or a base station (e.g., a gNB) in case of downlink or uplink channel estimation. In separated channel estimation, a channel associated with a BS-RIS path

$$( e . g . , {a}_{m}^{′} )$$

and/or a channel associated with a RIS-WTRU path (e.g., bₘ) may be estimated individually. The channel estimation technique(s) applied may be dependent on a RIS state.

An example approach for cascaded channel estimation may include an on-off method. In the on-off method, channel estimation may be performed as a multiple-step (e.g., two-step) process where, in a first step, one or more (e.g., all) RIS elements may be turned off and a direct channel may be estimated, and in a second step, the RIS elements of the RIS may be turned on (e.g., one-by-one) and the channel gains introduced by each RIS element may be calculated. The overall channel may be estimated by combining the channel gains from the direct path and the channel gains from the RIS elements.

An example for cascaded channel estimation may include an on method, which may avoid turning off RIS elements during pilots. Different φ (factor) vectors, e.g., orthogonal vectors, that may be known to a WTRU may be applied during the pilots. Direct and/or RIS-aided channels may be estimated by inverting the effect of the φ vectors.

A large number of RIS elements may make a channel estimation task computationally intensive. Channel estimation in a RIS-aided communication may be performed on multiple communication paths (e.g., both of the communication paths described herein). Hardware limitations and/or the use of infinite resolution phase shifter may make channel estimation difficult in practical implementations. The resolution of phase shifters may define the number of possible states achievable by a RIS. Discrete phase shifters (e.g., which may be practically utilized) may introduce quantization errors that may affect the channel estimation at a receiver.

The example system model described herein may be applicable to a sub-carrier in a wideband multi-carrier system, e.g., using OFDM. A pilot considered herein may be transmitted on a sub-carrier. Signals may be transmitted on sub-carriers. Pilots may be simultaneously transmitted on (e.g., multiple) sub-carriers across a bandwidth.

Channel estimation (e.g., improved channel estimation), for example, may be obtained by processing the received pilots on the sub-carriers.

Per-RIS element channels may be estimated. For example, to estimate the cascaded channel c in Equation 3 and/or the direct channel d, a network device may transmit a number of known pilot (reference) symbols x₀, x₁, . . . , x_{M}. Since c may include M elements and d may include one element, M+1 pilots may be used to estimate the channel coefficients.

For notation, the same pilot symbol s are assumed herein in M+1 occasions, and the pilot symbols may be different in different occasions (e.g., according to a certain complex-value sequence, as long as it is known by a WTRU). Received pilot symbols may be combined, e.g., in accordance with Equation 4 below:

$$y = h Θ x + z \qquad ( 4 )$$

wherein y=[y₀ . . . y_{M}] may represent the M+1 received pilot symbols and h=[d c] may represent a 1×(M+1) vector with a direct channel and M channels via the RIS. Θ may be equal to

$$[ \begin{matrix}1 & ⋯ & 1 \\ {Φ}_{0} & ⋯ & {Φ}_{M}\end{matrix} ] ,$$

where φᵢ may be an M×1 vector with RIS element factors during the i:th pilot symbol, and Θ may be a square matrix with a dimension of (M+1)×(M+1). Θ may be called a RIS estimation matrix. z=[z₀ . . . z_{M}] may represent a 1×(M+1) dimensional vector associated with received noise and/or interference.

In examples (e.g., with RIS estimation matrix Θ having a full rank known to the WTRU), the channels may be estimated based on y, e.g., in accordance with Equation 5 below (e.g., using the RIS estimation matrix). The channels may be estimated using a method such as one based on minimum mean square errors (MMSE).

$$\hat{h} = \frac{1}{x} y {Θ}^{- 1} \qquad ( 5 )$$

Φᵢ may be designed using approaches. For example, in the on-off method described herein, RIS elements (e.g., all RIS elements) may be turned off, e.g., during a pilot symbol such as a first pilot symbol where Φ₀=0 or Φ₀≈0. Turning the RIS elements off may result in a received symbol such as y₀=dx+z₀. The direct channel d may be estimated by the WTRU,

For example, during pilot symbols 1 to M, RIS elements may be turned on one-by-one (e.g., with other elements still turned off). Turning the RIS elements on may result in a i:th pilot symbol being received, for example, as in Equation 6.

$${y}_{i} = ( c {Φ}_{i} + d ) x + z = ( {c}_{i} {ϕ}_{i} + d ) x + {z}_{i} with i = 1 , … , M \qquad ( 6 )$$

For i>0, Φᵢ may be zero (e.g., all zero), except that the i:th element of the vector may be equal to 1 (e.g., Φᵢ=1). For example, Φ₁ may be equal to [1 0 . . . ]^{T}, Φ₂ may be equal to [0 1 0 . . . 0]^{T}, etc. Or (e.g., equivalently), [Φ₁ . . . Φ_{M}]=I_{M}, wherein I_{M} may be a M-dimensional identity matrix. This presentation may assume that the RIS elements may be turned on in the order of RIS element indices, and those skilled in the art will understand that the elements may be turned on in an order.

In examples (e.g., such as the on method described herein), Φᵢ may be vectors without elements equal to zero. This may mean that multiple (e.g., all) RIS elements may be turned on during pilot symbol transmissions. In examples, Θ may be a DFT matrix. In examples, Θ may be a Hadamard matrix. RIS states during the pilots may be based on the columns of a DFT matrix or a Hadamard matrix. In at least these examples, Θ⁻¹ may be equal to Θ^{T} which may simplify implementation.

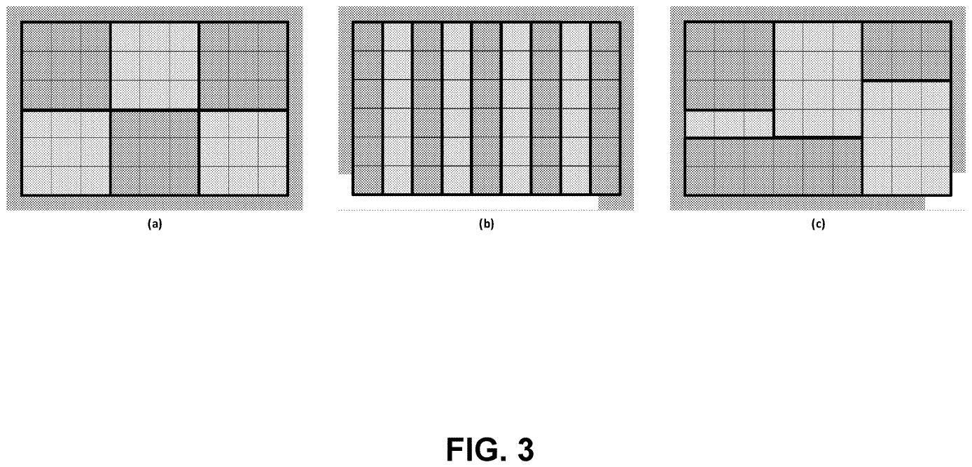

In examples, the number of RIS elements on a RIS may be high. Channel estimation and/or CSI reporting per RIS element may be costly, e.g., in terms of overheads and signaling. The cost may be reduced, for example, by introducing sub-surface-based estimation and reporting. The RIS elements may be distributed (e.g., grouped) into S sub-surfaces including, e.g., Sₕ horizontal elements and S_{y} vertical elements in a sub-surface. The distribution of the RIS elements into the sub-surfaces may be uniform (e.g., same number of RIS elements per sub-surface) or non-uniform (e.g., different numbers of RIS elements for different sub-surfaces). In examples of multi-panel RIS, a (e.g., each) panel may be considered a sub-surface, or a (e.g., each) panel may be divided into multiple sub-surfaces. FIGS. 3A-3C illustrate examples of IS element distribution into sub-surfaces. FIG. 3A and FIG. 3B illustrate examples of uniform distribution, and FIG. 3C illustrates an example of non-uniform distribution. In examples where different RIS surfaces may be allocated to different users, the number of RIS elements or resources allocated to a user (e.g., a WTRU) may be increased or decreased (e.g., non-uniform RIS distribution may be used). A WTRU requesting more resources may be allocated a sub-surface with a bigger dimension (e.g., having more RIS elements), and a sub-surface with a smaller dimension (e.g., having fewer RIS elements) may be reserved for a WTRU with a less-stringent request.

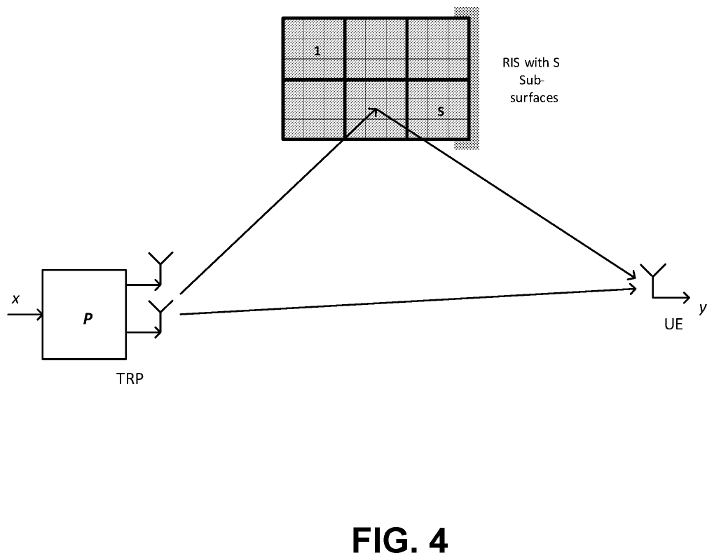

The number of pilots for CSI and/or channel acquisition may be M+1 (e.g., in the case of element-wise RIS aggregated channel estimation). With increased RIS surface size, the computational complexity of the estimation process may increase tremendously, making the process of channel estimation inefficient and/or time-consuming. In examples, channel estimation may be performed by dividing and/or grouping RIS elements into smaller groups (e.g., which may be referred to herein as sub-surfaces) and performing the channel estimation at a sub-surface level. Such a sub-surface may include a set of one or more RIS elements. The distribution of RIS elements into sub-surfaces may be uniform or non-uniform. In the case of multi-panel RIS, a (e.g., each) panel may be considered a sub-surface, or a (e.g., each) panel may be further divided into multiple sub-surfaces. FIG. 4. Illustrates an example of partitioning a RIS into six sub-surfaces (e.g., S=6).

An RIS state may be configured at a sub-surface level (e.g., the same RIS element factor may be applied to the RIS elements in a sub-surface). Sub-surface level channel estimation may be performed by sending a (e.g., one) pilot per sub-surface (e.g., rather than a pilot per RIS element). By introducing the sub-surfaces, the dimension of the channel estimation problem may be reduced from M+1 to S+1 (e.g., in terms of pilot transmissions and/or computation). The on-off method and/or the on method described herein may be applied to sub-surfaces (e.g., instead of to individual RIS elements), for example, to reduce pilot overheads and/or channel estimation complexity.

An RIS system described herein may be used to illustrate RIS operation based on sub-surfaces. Let Γⱼ denote a set of RIS element indices in the j:th sub-surface, with j=1, . . . , S. The union of sub-surfaces may include multiple (e.g., all) RIS element indices, e.g., ∪ⱼΓⱼ={1, . . . , M}, and the sub-surface sets may be disjoint. Let γⱼ be an M×1 vector with ones on the rows given by the indices in Γⱼ, and zeroes elsewhere (e.g., the row indexing may start at 1 for convenience). The RIS elements in γⱼ may be selected corresponding to the j:th sub-surface.

Let

$$G = [ \begin{matrix}{γ}_{1} & ⋯ & {γ}_{S}\end{matrix} ] = [ \begin{matrix}{η}_{1} \\ ⋮ \\ {η}_{M}\end{matrix} ]$$

be a sub-surface selection matrix of dimension M×S. The 1×S vector ηₘ may have a one on the column corresponding to the sub-surface to which the m^{th} RIS element belongs, and zeroes elsewhere.

Equation 3 (e.g., which may represent a system model) may be written as Equation 7 below:

$$y = ( c G {Φ}^{s} + d ) x + z = ( {c}^{s} {Φ}^{s} + d ) x + z \qquad ( 7 )$$

wherein Φ^{s} may represent a complex-valued vector of dimension S×1 including the S sub-surface factors φⱼ^{s}, where factor φⱼ^{s} may be applied to the RIS elements in Γⱼ, e.g., φₘ=φₛ^{j} ∀m∈Γⱼ, and the same RIS element factor φⱼ^{s} may be applied to an (e.g., each) element in the j:th sub-surface. c^{s}=cG may represent a 1×S dimensional vector including S per sub-surface RIS-reflected aggregate channels (e.g., the j:th element of c^{s} may equal Σ_{Γ}_{ⱼ}cₘ.

(c^{s}Φ^{s}+d) in Equation 7 may have the same form as (cΦ+d) in Equation 3, except for the length of the vectors, which may be S in the former (e.g., representing the number of sub-surfaces) and M in the latter (e.g., representing the number of RIS elements). A method for channel estimation, CSI, etc. that may be applicable to per RIS element operation may also be applicable to per sub-surface operation, and vice versa. For example, RIS channel estimation (e.g., per RIS element channel estimation) as described herein may be (e.g., directly) applicable to per sub-surface channel estimation by changing the problem dimension (e.g., adding an s superscript). For example, h=[d cₛ] may be used to represent a 1×(S+1) vector with a direct channel and S channels via the RIS sub-surfaces, and Θ may be adapted to

$$Θ = [ \begin{matrix}1 & 1 & ⋯ & 1 \\ {Φ}_{0} & {Φ}_{1}^{s} & ⋯ & {Φ}_{S}^{s}\end{matrix} ]$$

where Φᵢ^{s} may represent an S×1 vector with RIS sub-surface factors during an i:th pilot symbol, and Θ may be a square matrix with dimension (S+1)×(S+1).

For the S sub-surfaces, S+1 pilots may be utilized to estimate a cascaded channel for each sub-surface. For example, the description on RIS channel estimation may be applicable by changing the problem dimension by adding the s superscript. The cascaded channel may be estimated by a WTRU as illustrated by Equation 8 below:

$$y = {h}^{s} {Θ}^{s} x + z \qquad ( 8 )$$

wherein y=[y₀ . . . y_{S}] may represent S+1 received pilot symbols, h^{s}=[d c] may represent a (1×(S+1)) vector with a direct channel and S channels via S RIS sub-surfaces,

$${Θ}^{s} = [ \begin{matrix}1 & 1 & ⋯ & 1 \\ {Φ}_{0}^{s} & {Φ}_{1}^{s} & ⋯ & {Φ}_{S}^{s}\end{matrix} ] where {Φ}_{i}^{s}$$

may be the S×1 vector with the RIS sub-surface factors during the i^{th} pilot symbol (e.g., the RIS estimation matrix Θ^{s} may be a square matrix with dimension (S+1)×(S+1), and z=[z₀ . . . z_{S}] may represent a (1×(S+1))-dimensional vector associated with received noise and/or interference.

Based on this, with a RIS estimation matrix Θ^{s} as a full rank matrix that may be known to the WTRU, channels may be estimated based on the received pilots y, e.g., as illustrated by Equation 5 or using other suitable techniques. For example, in the on-off method described herein, RIS sub-surfaces (e.g., all RIS sub-surfaces) may be turned off in a first step

$$( e . g . , {Φ}_{0}^{s} = 0 or {Φ}_{0}^{s} \approx 0 )$$

to acquire the direct link coefficients during a first pilot symbol transmission. This may result in a received symbol. From a second pilot symbol onwards (i=1, . . . , S), a (e.g., one) sub-surface may be turned on, while others may still remain off. For instance, the j:th received pilot as reflected by the j^{th} sub-surface may be as illustrated in Equation 6, but with i=1, . . . , S.

In the sub-surface-based techniques described herein, if within a (e.g., each) sub-surface element-wise channel gain acquisition is performed, the sub-surface based estimation may be same as element-wise channel estimation, e.g., requiring M+1 pilot symbols.

In the case of a rectangular RIS with uniform sub-surfaces, if the number of sub-surfaces in a horizontal direction is denoted as Sₕ and the number of sub-surfaces in a vertical direction be denoted as Sᵥ, S may be equal to Sₕ*Sᵥ.

A first mode of DL CSI acquisition (e.g., associated with NR) may be based on a WTRU performing measurements on one or more CSI-RS and reporting corresponding CSI. A second mode of DL CSI acquisition (e.g., associated with NR) may be based on a WTRU transmitting a sounding reference signal (SRS), e.g., including antenna switching between antennas that may be used for DL reception, CSI measurement at the network side, and/or the assumption of UL/DL reciprocity (e.g., CSI estimated on the UL may be applicable to the DL),

A WTRU may be configured to perform channel measurement and/or compute CSI using a CSI-RS resource, which may include one or multiple ports (e.g., antenna ports). One or multiple CSI-RS resources may be grouped into a CSI-RS resource set. A WTRU may be configured to perform interference and/or noise measurement on a CSI-RS resource for a CSI. A CSI-RS resource may be a non-zero power (NZP) CSI-RS resource, in which a WTRU may assume a certain RS being transmitted. A CSI-RS resource may be a CSI-RS resource for interference measurement, in which a WTRU may not assume a certain RS being transmitted. CSI-RS resources and resource sets may be, for example, non-zero power (NZP) CSI-RS resources and resource sets or interference measurement (IM) CSI-RS resources or resource sets. For brevity, the terms CSI-RS resource(s) and CSI-RS resource set(s) are used herein, which may refer to either NZP and/or IM CSI-RS resource(s) and resource set(s).

A CSI-RS resource may be periodic, semi-persistent (e.g., which may be activated/deactivated), or aperiodic (e.g., which may be triggered). A WTRU may be configured with periodic, semi-persistent, or aperiodic CSI reporting. Periodic CSI reports may be transmitted on the PUCCH, while aperiodic CSI reports may be transmitted on the PUSCH. Semi-persistent CSI reports may be configured to be transmitted on the PUCCH or on a semi-persistent PUSCH.

A CSI report may be based on channel measurements on a resource set, e.g., a CSI-RS resource set. A (e.g., each) channel measurement resource may be associated with an interference measurement resource and/or a non-zero power CSI-RS resource for interference measurement.

A WTRU may report CSI corresponding to one or more resources in a resource set for channel measurement. If the resource set includes multiple resources, the WTRU may report a resource index, for example, to identify the corresponding resource used. Such a resource index may include a CSI-RS resource indicator (CRI) or an SSB resource indicator (SSBRI).

In examples (e.g., if a multi-port CSI-RS is used as a channel measurement resource), a WTRU may be configured to compute one or more precoding matrix indicators (PMI), e.g., a wideband PMI and/or a number of sub-band PMIs. A PMI may, for instance, correspond to a precoding vector or matrix selected directly from a codebook. A PMI may include a combination (e.g., linear combination) of multiple precoding vectors or matrices from a codebook.

A CSI report may include one or more channel quality indicators (CQI). If the CSI report includes a PMI, the CQI may correspond to a set of layers of the PMI. A CSI report may include a wideband CQI (e.g., if wideband PDSCH transmission is performed). A CSI report may include sub-band CQI (e.g., if sub-band PDSCH transmission is performed).

The network may determine a RIS state (e.g., a suitable RIS state) for a WTRU (e.g., an RIS state to use to transmit to and/or receive from the WTRU) based on CSI feedback from the WTRU. A suitable RIS state may be associated with one or more conditions being met or metric(s) being modified (e.g., optimized), e.g., under certain constraint(s). The one or more conditions may include one or more of a minimum quality-of-service, a minimum SINR, etc. The metric(s) may include one or more of: SNR, SINR, data rate, spectral efficiency, etc. The RIS state for the WTRU may be indicated from the network to the RIS, such that it may be used for subsequent transmissions. RIS state estimation may be associated with (e.g., require) the transmission of reference signals. The RIS state may change with time, for example, due to WTRU mobility.

When the RIS state (e.g., suitable RIS state) changes with time, the RIS state may be correlated with the previous suitable IRIS state. By utilizing the prior IRIS state in the RIS CSI acquisition, overhead and latency of determining a new RIS state may be reduced.

For a static WTRU, an initial RIS state may be suitable (e.g., not optimal), e.g., due to limited reference signal transmission, CSI feedback resolution, etc. In such a case, it may be beneficial to utilize the prior (e.g., initial) RIS state(s) for enhancing the current RIS CSI acquisition, for example to converge towards an (e.g., optimal) RIS state.

Action(s) performed for enhanced CSI feedback may be based on a prior RIS state. A system model description may be described herein.

CSI acquisition may be enhanced to facilitate adaptive configuration of a reconfigurable intelligent surface (RIS) that has been deployed in a wireless communication system. Enhancements may involve a WTRU, a RIS, and/or a base station, and the communication link performance may be improved with limited overhead.

The WTRU and RIS may be configured with a two-level RIS CSI procedure. The WTRU may measure an RIS CSI (e.g., more extensive RIS CSI) with a uniform phase shift distribution in the level 1 RIS CSI procedure (e.g., in a first RIS CSI procedure) and an RIS CSI (e.g., less extensive RIS CSI) with a non-uniform phase shift distribution centered around 0 in the level 2 RIS CSI procedure (e.g., a second RIS CSI procedure).

For the level 2 RIS CSI procedure, the RIS may include the prior RIS state in the RIS states applied during pilots. The WTRU may recommend (e.g. typically recommend) RIS element factors close to 1 (phase shift 0) in level 2 RIS CSI. The RIS element factors close to 1 may be exploited to reduce level 2 RIS CSI overhead.

In the presentation of RIS channel estimation described herein, the WTRU may estimate the per RIS element channel based on the knowledge of the RIS state. The model may be applied to sub-surface channels for reduced complexity and overhead.

In examples, the RIS-reflected cascaded BS to RIS element to WTRU channel cₙ that is to be estimated may be separate from the RIS element factor φₙ (e.g., see, for example Equation 2). For example, the cascaded channel c₁, may be seen as including an RIS element factor equal to 1. The RIS-reflected cascaded BS to RIS sub-surface to WTRU channel c^{s} that is to be estimated may be separate from the RIS sub-surface factor

$${ϕ}_{j}^{s} .$$

In examples where a prior RIS state may be taken into account, the WTRU may estimate the per element/sub-surface channel given an RIS state, e.g., that may be transparent to the WTRU. For example, the enhanced system model may be considered in Equation 9.

$$y = ( ( c ⊙ {\overline{Φ}}^{T} ) Φ + d ) x + z = ( \overline{c} Φ + d ) x + z = ( c \tilde{Φ} + d ) x + z \qquad ( 9 )$$

Φ̅ may be a prior RIS state (dimension M×1). It may be transparent to the WTRU. Φ̅^{T} may denote the transpose of Φ̅. Φ may be known to the WTRU and may be included in Θ (dimension M×1). c̅=c⊙Φ̅^{T} may be the effective RIS-reflected channel seen by the WTRU (dimension 1×M). \tilde{Φ}=Φ̅ ⊙Φ may be the RIS state applied by the RIS (dimension M×1). \tilde{Φ} may correspond to the RIS state to be used during pilot symbols, Φ̅ may correspond to the prior RIS state, and Φ may correspond to (or be included in) the estimation matrix.

The enhanced system model in Equation 10 may be used, e.g., for sub-surface based operation.

$$y = ( {c}^{s} ( {\overline{Φ}}^{s} ⊙ {Φ}^{s} ) + d ) x + z = ( {\overline{c}}^{s} {Φ}^{s} + d ) x + z = ( {c}^{s} {\tilde{Φ}}^{s} + d ) x + z \qquad ( 10 )$$

Equation 10 may include similar notation as for Equation 9 and may be based on sub-surfaces.

Feature(s) described herein may be associated with an element-level prior RIS state and sub-surface level CSI. Since an element-level RIS state may (e.g., eventually) be used for communication with the WTRU, it may be advantageous if the prior RIS state is an element-level RIS state (e.g., that different RIS elements in a sub-surface may have different RIS element factors).

For example, consider the system model in Equation 11:

$$y = ( ( c ⊙ {\overline{Φ}}^{T} ) G {Φ}^{s} + d ) x + z = ( {\check{c}}^{s} {Φ}^{s} + d ) x + z = ( c \check{Φ} + d ) x + z \qquad ( 11 )$$

The notation may be as previously defined herein, and in examples: č^{s}=(c⊙Φ̅^{T})G may be the effective RIS-reflected sub-surface channel seen by the WTRU (dimension 1×S). It may include the prior per RIS-element factors Φ̅. Φ̌=Φ̅⊙(GΦ^{s}) may be the RIS state applied by the RIS (dimension M×1). The sub-surface selection matrix G of dimension M×S may be as defined herein.

In examples, in the sub-surface based on-off method, a turned-on sub-surface may be turned on with ones as factors (e.g., Φ^{s}=[1 0 . . . ]^{T} if only the first sub-surface is on) and with an element-level RIS state Φ̅, e.g., that may have been found suitable/beneficial, for example, based on a previous RIS CSI report. In certain examples, the vector Φ^{s} may still indicate which sub-surface that is turned on. In a (e.g., normal) sub-surface-based operation (see for example equation 3), the same factor may be applied to the RIS elements in the sub-surface. In examples, if an element in Φ^{s} is equal to ‘1’ the RIS state for the RIS elements (e.g., all RIS elements) that belong to the sub-surface may be equal to ‘1.’ A prior element-level RIS state Φ̅ may be available, e.g., RIS elements (e.g., different RIS elements) in a sub-surface (e.g., each sub-surface) may have separate RIS states (e.g., which may be different). In Φ̌, if a sub-surface in Φ^{s} is turned on with a ‘1,’ the RIS states in the turned-on sub-surface may not all be equal to ‘1’ and equal to the RIS states given by Φ̅. The mapping between a sub-surface and a set of RIS elements may be defined through G. A RIS state that was found beneficial may, for example, have been reported by the WTRU before or have been used for DL/UL communication, or otherwise have been determined to be suitable (e.g., as described herein).

Feature(s) described herein may be associated with channel estimation with a prior RIS state. For channel estimation, the WTRU may use the same kind of methods as without a prior RIS state, e.g., by multiplying the received symbols with the inverse RIS estimation matrix Θ⁻¹ (or a function thereof), for example, as described herein for an element-wise estimation

$$( e . g . , with RIS estimation matrix Θ = [ \begin{matrix}1 & ⋯ & 1 \\ {Φ}_{0} & ⋯ & {Φ}_{M}\end{matrix} ] ) ,$$

or as described herein for sub-surface based estimation

$$( e . g . , with RIS estimation matrix {Θ}^{s} = [ \begin{matrix}1 & 1 & ⋯ & 1 \\ {Φ}_{0}^{s} & {Φ}_{1}^{s} & ⋯ & {Φ}_{S}^{s}\end{matrix} ] ) ,$$

or as described herein for element-level prior IRIS state and sub-surface level channel estimation (e.g., also with RIS estimation matrix Θ^{s}).

The effective channel h may be formulated as follows, depending on the case: h̅=[d c̅] for element-level prior RIS state and element-level channel estimation; h̅^{s}=[d c̅^{s}] for sub-surface-level prior RIS state and sub-surface-level channel estimation;

[symbol]

for element-level prior RIS state and sub-surface-level channel estimation. The corresponding received pilots for the three cases above may be given as follows in Equation 12, Equation 13 and Equation 14.

$$y = \overline{h} Θ x + z \qquad ( 12 )$$

$$y = {\overline{h}}^{s} {Θ}^{s} x + z \qquad ( 13 )$$

$$y = {\check{h}}^{s} {Θ}^{s} x + z \qquad ( 14 )$$

Given that the RIS estimation matrix Θ, or Θ^{s}, and its inverse Θ⁻¹ and (Θ^{s})⁻¹ exist and are known to the WTRU, the channel may be estimated as in Equation 5.

In an example of element-level prior RIS state and element-level channel estimation y=h̅Θx+z, the effective channel may be estimated, for example, as in Equation 15.

$$\hat{h} = \frac{1}{x} y {Θ}^{- 1} = \overline{h} + \frac{1}{x} z {Θ}^{- 1} = [ d \overline{c} ] + {z}^{′} \qquad ( 15 )$$

In an example involving sub-surface level prior RIS state and sub-surface level channel estimation, y=h̅^{s}Θ^{s}x+z, the effective channel may be estimated, for example, as in Equation 16.

$$\hat{h} = \frac{1}{x} y {( {Θ}^{s} )}^{- 1} = {\overline{h}}^{s} + \frac{1}{x} z {Θ}^{- 1} = [ d {\overline{c}}^{s} ] + {z}^{′} \qquad ( 16 )$$

In an example involving element-level prior RIS state and sub-surface level channel estimation, y= [symbol] ^{s}Θ^{s}x+z, the effective channel may be estimated, for example, as in Equation 17.

$$\hat{h} = \frac{1}{x} y {( {Θ}^{s} )}^{- 1} = {\check{h}}^{s} + \frac{1}{x} z {Θ}^{- 1} = [ d {\check{c}}^{s} ] + {z}^{′} \qquad ( 17 )$$

Feature(s) described herein may be associated with an ideal RIS State. With ideal channel estimation, e.g., with z=0, for example, for the case with element-level channel estimation and without the application of a prior RIS state, this may be formulated, for example, in Equation 18.

$$\hat{h} = \frac{1}{x} y {Θ}^{- 1} = [ d c ] + \frac{1}{x} z {Θ}^{- 1} = [ d c ] = h \qquad ( 18 )$$

Consider ideal CSI feedback and no temporal fading during a considered time interval. With c^{H} denoting the Hermitian transpose of c, the RIS state that maximizes the received signal power (SNR) may be selected such that ∠(c₁φ₁)= . . . =∠(c_{M}φ_{M})=∠d, where ∠d denotes the angle of the complex number d, and α₁= . . . =α_{M}=αₘₐₓ, with notation as described herein. This may be formulated, for example, as in Equation 19.

$${Φ}_{opt} = [ \begin{matrix}{ϕ}_{opt , 1} \\ ⋮ \\ {ϕ}_{opt , M}\end{matrix} ] = [ \begin{matrix}\frac{{α}_{max}}{\vert d \vert \vert {c}_{1}^{*} \vert} d {c}_{1}^{*} \\ ⋮ \\ \frac{{α}_{max}}{\vert d \vert \vert {c}_{M}^{*} \vert} d {c}_{M}^{*}\end{matrix} ] \qquad ( 19 )$$

In Equation 19,

$${c}_{m}^{*}$$

may be the complex conjugate of

$${c}_{m} ; {α}_{opt , m} = \vert \frac{{α}_{max}}{\vert d \vert \vert {c}_{m}^{*} \vert} d {c}_{M}^{*} \vert = {α}_{max}$$

be the amplification of the m^{th} RIS element; and

$${β}_{opt , m} = ∠ ( {ϕ}_{opt , m} ) = ∠ ( \frac{{α}_{max}}{\vert d \vert \vert {c}_{m}^{*} \vert} d {c}_{m}^{*} ) = ∠ ( d {c}_{m}^{*} ) = ∠ ( d ) - ∠ ( {c}_{m} )$$

may be the phase shift of the m^{th} IRIS element.

Using the Φₒₚₜ above as the prior RIS state under these ideal conditions, the received signal may be given, for example, by Equation 20:

$$y = ( c {Φ}_{opt} + d ) x + z = ( \frac{{α}_{max}}{\vert d \vert} ‖ c ‖ d + d ) x + z \qquad ( 20 )$$

The received signal from the RIS-aided path may be phase aligned (e.g., perfectly phase aligned) with the direct path (e.g., for maximum received signal power).

Feature(s) described herein may be associated with channel estimation based on an ideal prior RIS state. Following Equation 15 (ĥ=[d c̅]+z′), and using an ideal prior RIS state (Φ̅=φₒₚₜ), as in Equation 19, the estimated channel may be:

$$\hat{h} = [ d \overline{c} ] + {z}^{′} = [ d c ⊙ {Φ}_{opt}^{T} ] + {z}^{′} = {\underbrace{[ 1 \frac{{α}_{max}}{\vert d \vert} \vert c \vert ]}}_{real} d + {z}^{′} \qquad ( 21 )$$

|c| may be an 1×M row vector with the magnitudes of the elements of c. With ideal channel estimation also in this stage, e.g., with the noise-less assumption z′=z=0, the estimated effective channels in c̅ (e.g., all the estimated effective channels in C) may have the same phase as d. Additional RIS state adjustment may not be needed, since the prior RIS state may be adjusted to the channel h.

With realistic channel estimation in this stage, e.g., z′≠0, the estimated effective channels in ĥ=[d c̅] may not be phase aligned. This may be due to, for example, temporal channel fading between the pilot reception for the prior RIS state estimation and the subsequent pilot reception. Channel estimation based on a realistic prior IRIS state may be further discussed herein.

The case with element-level prior RIS state and element-level channel estimation may be used as an example. Similar results may hold, for example, with sub-surface-level prior RIS state and sub-surface-level channel estimation, or element-level prior RIS state and sub-surface-level channel estimation.

Channel estimation may be based on a realistic prior RIS state. The prior RIS state may not be perfectly adjusted (e.g., phase aligned with a subsequent channel) due to realistic RIS CSI feedback or RIS state signaling to the RIS, e.g., due to quantization, parameterization, compression, etc.

Instead of applying the (e.g., optimal or ideal) prior RIS state at the m^{th} element φ_{opt,m}, the realistic prior RIS state may include additional RIS element phase shifts compared to the optimal or ideal RIS state, e.g., e^{-jΔβ}^{ₘ}, where Δβₘ may be seen as a phase shift error of the m^{th} RIS element e.g., compared to an ideal phase shift. A corresponding expression for a realistic RIS state may be given in Equation 22, wherein the vector f (dimension M×1) may contains the M phase shift errors.

$$\overline{Φ} = {Φ}_{opt} ⊙ [ \begin{matrix}{e}^{- j {Δβ}_{1}} \\ ⋮ \\ {e}^{- j {Δβ}_{M}}\end{matrix} ] = {Φ}_{opt} ⊙ f \qquad ( 22 )$$

Feature(s) described herein may be associated with element-level prior RIS state and element-level channel estimation. Following Equation 15 (ĥ=[d c̅]+z′) and using the realistic prior RIS state P, the estimated channel may be as in Equation 23.

$$\begin{matrix}\hat{h} = [ \begin{matrix}d & \overline{c}\end{matrix} ] + {z}^{′} \\ = [ \begin{matrix}d & c ⊙ {\overline{Φ}}^{T}\end{matrix} ] + {z}^{′} \\ = [ \begin{matrix}d & {\underbrace{c ⊙ {Φ}_{opt}^{T} ⊙ {f}^{T}}}_{{M RIS - aided}_{paths}}\end{matrix} ] + {z}^{′} \\ = [ \begin{matrix}d & {\underbrace{\frac{{α}_{m ax}}{\vert d \vert} \vert c \vert}}_{real} ⊙ {f}^{T} d\end{matrix} ] + {z}^{′}\end{matrix} \qquad ( 23 )$$

Due to imperfection(s), the phases of the RIS-aided paths may be different from the phase of the direct path, e.g., ∠(d)≠∠(f(m)d) for the path via the m^{th} RIS element. If the errors are small, e.g., f≈1, the direct and RIS-aided paths may (e.g., roughly) add up constructively.

Feature(s) described herein may be associated with an element-level prior RIS state and sub-surface level channel estimation. Following Equation 17 (ĥ=[d č^{s}]+z′) and using the realistic prior RIS state Φ̅, the estimated channel may be as in Equation 24.

$$\begin{matrix}\hat{h} = [ \begin{matrix}d & {\check{c}}^{s}\end{matrix} ] + {z}^{′} \\ = [ \begin{matrix}d & ( c ⊙ {\overline{Φ}}^{T} ) G\end{matrix} ] + {z}^{′} \\ = [ \begin{matrix}d & {\underbrace{( c ⊙ {Φ}_{opt}^{T} ⊙ {f}^{T} ) G}}_{{s RIS - aided}_{paths}}\end{matrix} ] + {z}^{′} \\ = [ \begin{matrix}d & ( {\underbrace{\frac{{α}_{ma x}}{\vert d \vert} \vert c \vert}}_{real} ⊙ {f}^{T} ) Gd\end{matrix} ] + {z}^{′} \\ = [ \begin{matrix}d & {\tilde{f}}^{T} Gd\end{matrix} ] + {z}^{′}\end{matrix} \qquad ( 24 )$$

$${\tilde{f}}^{T} = \frac{{α}_{m ax}}{\vert d \vert} \vert c \vert ⊙ {f}^{T}$$

may be a complex-valued M×1 dimensional vector. Due to the various imperfections, the phases of the elements in \tilde{f} may be non-zero. \tilde{f}^{T}G may be a complex-valued S×1 dimensional vector. The M-dimensional \tilde{f} may be projected to an S-dimensional vector via the sub-surface selection matrix G, by adding the components from the RIS elements in a sub-surface. Since the phases of \tilde{f} may be non-zero, the phases of \tilde{f}^{T}G may be non-zero.

In examples, consider a scenario with two sub-surfaces, e.g., a first and a second half of the RIS. This means that S=2 and the first column of G may correspond to the first (e.g., left or upper) half, and the second column of G may correspond to the second (e.g., right or lower) half, e.g.,

$${Γ}_{1} = \{ 1 , 2 , … , \frac{M}{2} \} and$$

$${Γ}_{2} = \{ \frac{M}{2} + 1 , … , M \} ,$$

as illustrated in Equation 25.

$$G = [ \begin{matrix}1 & 0 \\ ⋮ & ⋮ \\ 1 & 0 \\ 0 & 1 \\ ⋮ & ⋮ \\ 0 & 1\end{matrix} ] \qquad ( 25 )$$

In examples, \tilde{f}^{T}G may be given by Equation 26.

$${\tilde{f}}^{T} G = \frac{{α}_{m ax}}{\vert d \vert} [ \begin{matrix}{\sum }_{m ∈ {Γ}_{1}} \vert {c}_{m} \vert {e}^{- j {Δβ}_{m}} & {\sum }_{m ∈ {Γ}_{2}} \vert {c}_{m} \vert {e}^{- j Δ {β}_{m}}\end{matrix} ] = [ \begin{matrix}{μ}_{1} & {μ}_{2} ] = μ\end{matrix} \qquad ( 26 )$$

With an exemplary ideal prior RIS state, Δβₘ=0 for m (e.g., all m), e.g., the sub-surface phase error values \tilde{f}^{T}G=[μ₁ μ₂] may be real. With a realistic prior RIS state, μ₁ and/or μ₂ may introduce a phase shift.

The estimated channel in Equation 24 may be formulated as in Equation 27.

$$\hat{h} = [ \begin{matrix}\hat{d} & ρ\end{matrix} ] = [ \begin{matrix}\hat{d} & {ρ}_{1} & ⋯ & {ρ}_{S}\end{matrix} ] = [ \begin{matrix}d & μ d\end{matrix} ] + {z}^{′} \qquad ( 27 )$$

\hat{d}=d+z′₀ may be the estimated direct path channel, ρₛ=μₛd+z′ₛ may be the estimated s^{th} RIS-aided channel, and

$${z}_{s}^{′}$$

may be the s^{th} element of the noise and interference vector z′.

An RIS CSI may be based on channel estimates including prior RIS state. CSI feedback of the estimated direct path channel \hat{d} may be less useful (e.g., since the RIS may have no impact on this channel). The channels in ρ, may include the RIS. ρ may include an estimate of the direct path channel through the prior RIS state, as seen in Equation 19 and Equation 23. If the network does not know the direct channel, which may be assumed, it may be less useful to report an RIS CSI that (e.g., directly or indirectly) includes a direct channel.

It may be useful to have the WTRU report sub-surface phase error values, \hat{μ}ₛ or ∠(\hat{μ}ₛ), or a function thereof, e.g., a parameterization, quantization, etc., e.g., as in Equation 28.

$$∠ ( {\hat{μ}}_{s} ) = ∠ ( {ρ}_{s} {\hat{d}}^{*} ) \qquad ( 28 )$$

In examples, Δβₘ may be equal for all m in the s^{th} sub-surface (Δβₘ=Δβ ∀m∈Γₛ), Δβ for the s^{th} sub-surface may be (e.g., directly) given by ∠(μₛ). The RIS state of the sub-surface may be adjusted based on the reported ∠(\hat{μ}ₛ) and used in a new prior RIS state by the network (e.g., by a base station or RIS controller).

In examples, Δβₘ may not be equal for all m in the s^{th} sub-surface, but either positive or negative (e.g., Δβₘ≥0). The sign of these phase errors may be estimated from the reported ∠(\hat{μ}ₛ).

A RIS CSI per RIS element may be estimated and reported (e.g., alternatively). For example, based on the channel estimate vector of length M+1, ĥ=[\hat{d} ρ], the WTRU may estimate an RIS element phase error for the m^{th} element as ∠(\hat{μ}ₘ)=∠(ρₘ\hat{d}*).

The RIS CSI may comprise estimated phase values, e.g., ∠(\hat{μ}ₛ) (or −∠(\hat{μ}ₛ)) for s=1, . . . , S (or the corresponding element-level estimation and reporting). The phase values may correspond to phase error values in relation to a prior RIS state, of which the WTRU may or may not be informed.

The RIS CSI may comprise a recommended RIS state, e.g., Φ or Φ^{s}, which may comprise phase shifts corresponding to ∠(\hat{μ}ₛ) (or −∠(\hat{μ}ₛ).

The WTRU may compute RIS CSI in the same way in the case that a prior RIS state is not applied during pilots and in the case that a prior RIS state is applied during pilots. In examples, the WTRU may compute RIS CSI differently, e.g., as discussed herein.

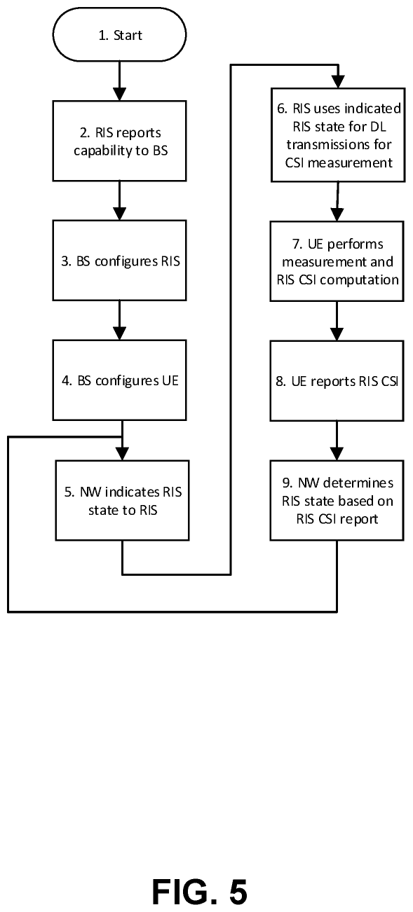

In examples, a system may include network nodes, such as one or more base stations (e.g., gNBs), one or more TRPs, one or more RISs, etc., and/or one or more WTRUs, etc. The context of the CSI procedure, for example, is discussed herein. FIG. 5 illustrates an example RIS CSI procedure, where one or more of the illustrated actions may be performed. In examples, a procedure may include nodes as illustrated in FIG. 5. Each node may perform its own actions, e.g., a WTRU procedure is described herein, an RIS procedure is described herein, etc.

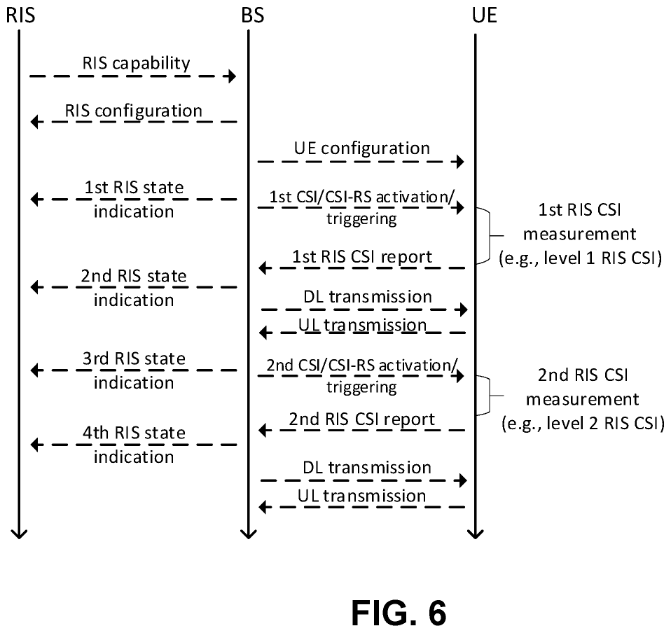

An example signaling diagram associated with RIS CSI measurement is shown in FIG. 6. Additional signaling may be used in examples described herein. Signaling may be omitted in examples herein.

This example may be based on the transmission of DL reference signals from the BS and RIS CSI measurement at the WTRU based on those DL reference signals. The resulting RIS CSI state may be used for both for DL and UL transmissions, e.g., in unpaired spectrum with time division duplex (TDD).

FIG. 6 illustrates an example signaling diagram, where one or more of the illustrated actions may be performed. A RIS capability may be signaled to the BS, e.g., as discussed herein. This may be followed by the BS configuring the RIS, e.g., as discussed herein. The BS may configure the WTRU, e.g., as discussed herein. The BS may indicate to the RIS one or more RIS states to be used in a 1st RIS state indication e.g., as discussed herein. This may be followed by a RIS CSI measurement by the WTRU, which may involve the BS transmitting CSI-RS. In examples of semi-persistent or aperiodic CSI-RS, corresponding activation or triggering signaling may be needed. The BS may indicate to the RIS to use a 1^{st} RIS state during times, e.g., to use a sub-surface level RIS state during the symbols during which CSI-RS for RIS CSI are transmitted, e.g., the sub-surface level RIS estimation matrix. Following the 1^{st} RIS CSI measurement and computation, the WTRU may report the 1^{st} RIS CSI to the BS, as described herein.

Based on the RIS CSI report, the BS (RIS controller) may compute a 2nd RIS state, e.g., perform RIS parameter interpolation to obtain a RIS-element level RIS state. The BS may indicate the 2nd RIS state to the RIS, e.g., for use during various subsequent transmissions, as discussed herein. This may be followed by DL/UL transmission(s) to/from the WTRU, during which the 2nd RIS state may be used.

The 3rd RIS state indication and 2nd RIS CSI measurement and reporting is described herein. For the 2nd RIS CSI measurement, e.g., in the case of semi-persistent or aperiodic CSI-RS or CSI reporting, corresponding activation or triggering signaling may be sent. The BS may schedule, e.g., in a 3rd RIS state indication, the use of an RIS-element level RIS state (e.g., RIS-element level prior RIS state and RIS-element level RIS estimation matrix) or a combination of a prior RIS-element level RIS state and a sub-surface level RIS estimation matrix, e.g., during the symbols carrying the CSI-RS resources and/or the symbols carrying the CSI report. Following the 2nd RIS CSI measurement and computation, the WTRU may report the 2nd RIS CSI to the BS.

Based on the RIS CSI report, the BS (or RIS controller) may compute a 4th RIS state, e.g., perform RIS parameter interpolation to obtain a RIS-element level RIS state. The BS may indicate the 4th RIS state to the RIS, e.g., for use during various subsequent transmissions, as discussed herein. This may be followed by DL/UL transmission(s) to/from the WTRU, during which the 4th RIS state may be used.

The signaling diagram in FIG. 6 is an example. In examples, features may be omitted (e.g., one or more of the RIS indications). In examples, features may be repeated before the next signaling occurs.

Reporting suggestive of RIS capability may be performed. RISs (e.g., different kinds or classes of RISs) may be supported in a network. For example, RISs in a network may differ in terms of: the number of RIS elements (e.g., M); the number of horizontal/vertical RIS elements (e.g., Mv, Mh); and/or the range and/or resolution of RIS element factors (e.g., RIS element amplifications and/or phase shifts).

A range may, for example, include a minimum and/or maximum value, e.g., for RIS element amplification. A resolution may, for example, include a step size between supported values, e.g., within a range. For example, a phase shift resolution of π/16 may be supported for an example (e.g., a RIS). A resolution/range capability may list the supported values. The supported space of RIS element factors may be defined through one or more codebook(s). A codebook may include a set of supported RIS states, where RIS states may include a set of RIS element factors. For example, a codebook may include a complex-valued matrix of dimension M×C, where C may be the number of RIS states in the codebook.

An RIS capability may include a set of parameters related to such aspects that may differ between RISs, e.g., parameters described herein. An RIS class may include one or more capabilities. An RIS may connect to the network and report its capabilities and/or class (e.g., class 1, class 2, etc.) to the network. The capabilities/class may be signaled using an RRC message.

Features described herein may be associated with a BS Configuration of a RIS. An RIS may be configurable by the network, e.g., by a BS or by an entity in the core network. The configuration may be an RRC configuration. The configuration may be transmitted to the RIS in a manner similar to how a WTRU is configured.

An RIS state may be used to describe a certain setting of the RIS element factors (e.g., amplification and/or phase shift), and sub-surface configuration and element-level configuration may refer to a configuration, e.g., an RRC configuration. Configuration parameters for an RIS may be conveyed using MAC layer signaling, e.g., a MAC CE, or physical layer signaling, e.g., a DCI.

The configuration parameters may include: one or more profiles, which may include a profile ID and one or more other parameters, e.g., parameters described as follows. A profile may correspond to one or more WTRUs. One or more sub-surface configurations, for example, may include one or more of the following: a sub-surface configuration ID; the number of sub-surfaces (e.g., S); the number of horizontal sub-surfaces (e.g., Sh) and the number of vertical sub-surfaces (e.g., Sv); the number of RIS elements per sub-surface; the number of RIS elements per horizontal and vertical sub-surface, respectively; an association between a sub-surface configuration (or sub-surface configuration ID) and a profile (or profile ID); or an association between a sub-surface configuration (or sub-surface configuration ID) and an element-level configuration (or element-level configuration ID).

One or more element-level configurations may be similar to a sub-surface configuration (e.g., similar parameters). While a sub-surface configuration may target sub-surface based RIS operation (e.g., all RIS elements in a sub-surface may use the same factor), an element-level configuration may target a RIS operation with factors per RIS element, e.g., without the use of sub-surfaces. Examples of an element-level prior RIS state and sub-surface level channel estimation may be considered herein. Examples may be based on a sub-surface configuration, or an element-level configuration, or a combination thereof, e.g., by an association between an element-level configuration and a sub-surface configuration.

An element-level configuration may be configured with an ID. An element-level configuration may be associated to a sub-surface configuration, e.g., by configuring a sub-surface configuration ID.

A time-domain configuration for sub-surface and/or element-level configuration(s) may indicate time instances when a configuration is to be used, for example, one or more of the following may be indicated: the configuration ID(s) to which the time-domain configuration applies (e.g., the time domain configuration may be included in a sub-surface and/or element-level configuration); time-domain behavior, e.g., periodic, semi-persistent, or aperiodic; periodicity, time offset, and/or duration (e.g., in terms of slots, symbols, or milliseconds); an indication that the configuration is applicable to periodic or semi-persistent time-domain behaviors; or, a numerology, e.g., an integer index μ that may correspond to a slot duration of 2^{-μ} (e.g., 2−μ) milliseconds, as in NR.

A trigger state configuration may be applicable to aperiodic time-domain behavior of a sub-surface or element-level configuration. The configuration may configure a set of trigger states, where a trigger state may correspond to a value of a parameter in a DCI. The configuration may associate a trigger state with a sub-surface and/or element-level configuration (e.g., ID).

Configuration of the range(s) and/or resolution(s) for a RIS element and/or sub-surface factors (amplification/phase-shifts) may be in the form of one or more codebooks, or one or more numbers of bits, e.g., the number of bits used to cover the range of phase shifts. Range(s)/resolution(s) for the case with an element-level prior RIS state and sub-surface based channel estimation may be included.

One or more RIS states (e.g., set of RIS element factors) may be associated with one or more sub-surface configurations or element-level configurations. Sub-surface configurations may (e.g., may not) be configured. Element-level configurations may be used. A sub-surface configuration may be used with a sub-surface being equal to a RIS element.

The network or base station (BS) may configure the WTRU with parameters related with RIS CSI enhancements, for example, one or more of the following: a sub-surface configuration, e.g., as described herein; a configuration for level 1 CSI measurement and reporting (e.g., see herein), e.g., CSI resource configuration(s) and/or CSI reporting configuration(s); and/or a configuration for level 2 CSI measurement and reporting, e.g., CSI resource configuration(s) and/or CSI reporting configuration(s). As described herein, a CSI and a RIS CSI may be used interchangeably.

The 1st WTRU RIS CSI measurement and reporting may be performed. The 1st WTRU RIS CSI measurement may be based on a WTRU measurement of pilots (e.g., reference signals, such as symbols) transmitted by the BS, e.g., CSI-RS. The BS may indicate to the RIS the RIS states to use during the pilot symbols, e.g., Φ₀ . . . Φ_{M} for element-level channel estimation or

$${Φ}_{0}^{s} \qquad ⋯ \qquad {Φ}_{S}^{s}$$

for sub-surface level channel estimation, as described herein, e.g., an indication of a RIS estimation matrix. The RIS states, e.g., in a RIS estimation matrix, may not be channel or WTRU dependent, and may be specified, pre-configured, or provided by the BS configuration of the RIS. For example, the ES may indicate to the RIS that S1+1 symbols are to be used for RIS CSI acquisition. Based on this indication, the RIS may determine the S1+1 RIS states for the S1+1 symbols, e.g., the (S1+1)-dimensional RIS estimation matrix. In examples, the BS may indicate to the RIS that S2+1 symbols are to be used for RIS CSI acquisition. Based on this indication, the RIS may determine the S2+1 RIS states for the S2+1 symbols, e.g., the (S2+1)-dimensional RIS estimation matrix. A set of RIS estimation matrices may be specified, pre-configured, and/or provided by the BS configuration of the RIS. The BS may indicate a RIS estimation matrices from the set of RIS estimation matrices, e.g., by an index, that includes the RIS states to be used by the RIS during the pilot symbols.

As described herein, the WTRU may estimate S+1 channels based on the S+1 pilots, which may include the direct channel. If the ES indicates different numbers of symbols for RIS CSI, e.g., S1+1 and S2+1, the RIS may change the number of used sub-surfaces between S1 and S2. In examples, this may be achieved by changing the sub-surface definition, such that both the S1 sub-surface and the S2 sub-surfaces cover the (e.g., whole) RIS. In a second example, the sub-surface definition may not be changed. The sub-surfaces not included in the S1 and S2 sub-surfaces may be turned off during the RIS CSI acquisition.

The indication may also include time-domain occasions, e.g., symbols, for when the RIS states are to be applied, e.g., in reference to the frame or sub-frame timing of a cell. The indication may refer to a configured time-domain configuration. In the case of semi-persistent or aperiodic CSI-RS, corresponding activation or triggering signaling may be included. Parameters of CSI-RS timing offset may refer to the time gap between aperiodic CSI-RS triggering and aperiodic CSI-RS transmission with regard to the number of slots/symbols. An aperiodic RIS CSI reporting timing offset may refer to the time gap between aperiodic CSI reporting triggering and aperiodic RIS CSI reporting with regard to the number of slots/symbols. In a case of periodic CSI-RS, indication of time-domain occasions may not be included.

The 1st WTRU RIS CSI measurement may be based on element-level or sub-surface level channel estimation, e.g., using M+1 or S+1 pilots, respectively, and a corresponding RIS estimation matrix (e.g., a first RIS CSI estimation matrix), e.g., as described herein.

The 1st WTRU RIS CSI report may convey the information of a 1st recommended RIS state. The CSI report may include various parameters, e.g., recommended phase shifts on a sub-surface level, that the network may use to generate the 1st recommended RIS state (e.g., using interpolation). In examples, the BS may generate an element-level RIS state (e.g., based on a RIS CSI report received from the WTRU). In examples, a RIS controller may generate an element-level RIS state, e.g., based on a sub-surface based RIS state or on another parameterization of lower complexity and granularity than an element-level RIS state obtained from the BS.

The BS may indicate a 2nd RIS state, e.g., a 1st recommended RIS state obtained from a 1st WTRU RIS CSI report. As discussed herein, the indication from the BS may include an element-level RIS state or a RIS state representation that the RIS controller may use to generate an element-level RIS state. In examples, the representation may include a sub-surface level RIS state, a codeword from a RIS state codebook, a parameterization of the RIS state, e.g., a phase shift gradient, etc.

In a numerical example, a RIS element factor may be represented by 6 bits, e.g., 64 phase-shift values and a fixed amplitude, and the RIS may have 100*100=10,000 RIS elements. The RIS state may include 64*10,000=640 kbits. The phase-shifts of adjacent elements may be correlated (e.g., the RIS state indication may be compressed). The size of an accurate element-level RIS state indication may be substantial.

The 2nd RIS state indication may include an ID (e.g., RIS state ID), so that the 2nd RIS state may be referenced, for example, so that the 2nd RIS state may be used during subsequent (e.g., optional) DL/UL transmissions to/from the WTRU, which are also shown in FIG. 6, or as a prior RIS state in subsequent RIS CSI measurement(s). The RIS state ID may be associated with a profile, a sub-surface configuration, IRIS element configuration, and/or time-domain configuration, as discussed herein.

A 2nd WTRU RIS CSI may be measured and reported. The 2nd WTRU RIS CSI measurement may be based on WTRU measurement of pilots (e.g., reference signals) transmitted by the BS, e.g., CSI-RS.

The BS may indicate to the RIS the RIS states to use during the pilot symbols that may include a prior RIS state, e.g., \tilde{Φ}₁ . . . \tilde{Φ}_{M} for element-level prior RIS state and channel estimation or

$${\tilde{Φ}}_{0}^{s} \qquad ⋯ \qquad {\tilde{Φ}}_{S}^{s}$$

for sub-surface level prior RIS state and channel estimation, as described herein, or

$${{Φ}^{︶}}_{0}^{s} \qquad ⋯ \qquad {{Φ}^{︶}}_{S}^{s}$$

for sub-surface level channel estimation with an element-level prior RIS state.

The BS may indicate to the RIS the prior RIS state (e.g., the 2nd RIS state), e.g., explicitly or implicitly, via its ID or an associated ID (e.g., profile). A field conveying a RIS state ID, profile ID, WTRU ID, or similar, may be included in a 3rd RIS state indication. The prior RIS state (or corresponding profile ID or WTRU ID) may be indicated or identified through other aspects of the control signaling to the RIS (or RIS controller). For example, the prior RIS state (or corresponding profile ID or WTRU ID) may be identified through the physical resources on which the control signaling to the RIS (e.g., RIS controller) was received. For example, a control resource set (CORESET) or a control channel search space may be associated with a profile ID or WTRU ID, and thereby implicitly to a prior RIS state. In examples, a radio network temporary identifier (RNTI) included in a received control channel signaling may be associated with a prior RIS state (or corresponding profile ID or WTRU ID). Separate signaling for a 3rd RIS state indication may not be needed, for example, if the identification of RIS states used for the 2nd RIS CSI measurement has been previously configured. For example, it may have been configured that the 2nd RIS state may be used as a prior RIS state during the 2nd RIS CSI measurement.

The RIS (e.g., RIS controller) may generate or compute the RIS state to be used during pilot symbols, e.g., using the 2nd RIS state as a prior RIS state and based on a configured and/or specified RIS estimation matrix Θ or Θ^{s}. This may result in lower control signaling compared to explicit indication of the effective RIS state, since the prior RIS state was already indicated to the RIS (e.g., RIS controller).

Similar to previous RIS state indications, the 3rd indication may include time-domain occasions.

The 2nd WTRU RIS CSI report may convey a 2nd recommended RIS state. The 2nd recommended RIS state may be in relation to the prior RIS state. As such, it may be seen as a recommended adjustment to the prior RIS state, which may be the 2nd RIS state. The CSI report may include various parameters, e.g., recommended phase shifts on a sub-surface level that the network may use to generate the 2nd recommended RIS state. e.g., using interpolation.

In examples, the BS may generate an element-level RIS state, e.g., based on the prior RIS state and on the 2nd RIS CSI report, e.g., the 2nd recommended RIS state.

In examples, a RIS controller may generate an element-level RIS state, e.g., based on a prior RIS state, which may be known by the RIS controller, and an adjustment indicated by the BS.

A 4th RIS State may be indicated. The BS may indicate a 4th RIS state, e.g., a 2nd recommended RIS state obtained from the 2nd WTRU RIS CSI report.

As discussed herein, the indication from the BS may include an element-level RIS state or a RIS state representation that the RIS controller may use to generate an element-level RIS state. For example, the representation may be a sub-surface level RIS state, a codeword from a RIS state codebook, a parameterization of the RIS state, e.g., a phase shift gradient, etc.

The indication from the BS may include an indication of a prior RIS state and a RIS state adjustment. The indication of a prior RIS state may be in the form of a WTRU ID, profile ID, or identity corresponding to the 2nd WTRU RIS CSI measurement and reporting, such as a corresponding resource ID or resource set ID. The RIS state adjustment parameter may be the same or different from a RIS CSI parameter reported by the WTRU in the 2nd WTRU IRIS CSI measurement and reporting. For example, the WTRU reports a 1-bit phase adjustment per sub-surface and the BS also indicates a 1-bit phase adjustment per sub-surface. The RIS may determine a new RIS element factor (or sub-surface factor), Φ_{new}, by multiplying the prior RIS element factor, Φ̅, with the adjustment factor, Φ_{adjustment}, e.g., Φ_{new}=Φ̅Φ_{adjustment}. In examples, a (e.g., new) RIS element factor (or sub-surface factor) may be determined by adding/combining the prior and the adjustment factor. For example, the RIS element phase may be adjusted directly, e.g., φ=φ̅+φ_{adjustment}, where φ_{new} is the new phase of a RIS element (or sub-surface), φ̅ is the prior phase, and φ_{adjustment} is the phase adjustment indicated to the RIS.

For example, the prior RIS state may be indicated similarly as for the 3rd RIS state indication. The indicated 4th RIS state may be used during subsequent (e.g., optional) DL/UL transmissions to/from the WTRU, which may be shown in FIG. 6. The RIS state ID may be associated with a profile, a sub-surface configuration, RIS element configuration, and/or time-domain configuration, as discussed herein. The 1st, 2nd, 3rd, and/or 4th RIS states may be associated with the same RIS state ID, profile, sub-surface configuration, RIS element configuration, and/or time-domain configuration, etc. The 1st, 2nd, 3rd, and/or 4th RIS states may be seen as refinements corresponding to the RIS state ID, etc.

An example summary of the 1st to 4th RIS state indications may be given herein. For a 1st RIS state indication, a purpose may be to include an indication of RIS states to be used during RIS pilots, e.g., the RIS states in the RIS estimation matrix Θ in Equation 4 or in Θ³ in Equation 8. Overhead may be low (e.g., very low), since Θ (or Θ′) may not change over time, or, if Θ (or Θ^{s}) changes, the indication may include few (e.g., very few) bits.

For a 2nd RIS state indication, a purpose may be to include an indication of a WTRU-specific RIS state to be used during DL/UL transmissions, e.g., data and control. Overhead may be high (e.g., very high), since the RIS state for the RIS elements or sub-surfaces (e.g., all RIS elements or sub-surfaces) may be conveyed. The RIS state may be based on the 1st WTRU RIS CSI measurement and reporting.

For a 3rd RIS state indication, a purpose may be to include an indication of RIS states to be used during RIS pilots that may be the product of a prior RIS state, e.g., from a 2nd or 4th RIS state indication, and the RIS states for RIS CSI, e.g., the RIS states in the RIS estimation matrix. Overhead may be low (e.g., very low), since the prior RIS state was indicated in another indication, e.g., 2nd or 4th RIS indication, and since the RIS estimation matrix typically doesn't change over time. The RIS may determine the RIS states to be used during RIS pilots as \tilde{Φ} (or \tilde{Φ}^{s}) for Equation 9 or Equation 10.

For a 4th RIS state indication, a purpose may be to include an indication of a WTRU-specific RIS state to be used during DL/UL transmissions, e.g., data and control. Overhead may be low or medium, since the RIS state indication may include a low-resolution increment compared to a prior RIS state.

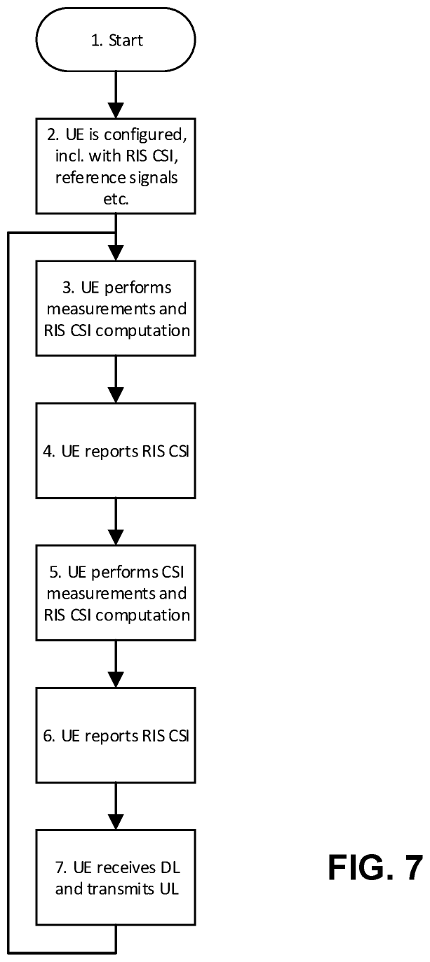

An example WTRU procedure may be illustrated in FIG. 7, where one or more of the illustrated actions may be performed. It may follow (e.g., roughly follows) the WTRU-side of the example procedure in FIG. 5. the WTRU may perform 3-6 differently depending on if the channel estimation and CSI is based on a prior RIS state or not, which may correspond to level 1 or level 2 CSI procedures discussed below.

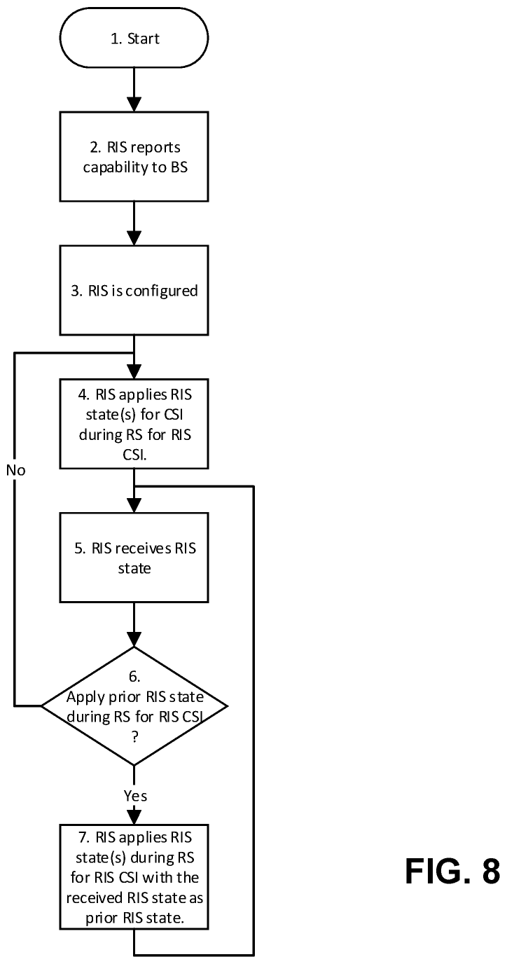

An example RIS procedure is illustrated in FIG. 8, where one or more of the illustrated actions may be performed. It may follow (e.g., roughly follow) the RIS-side of the exemplary procedure in FIG. 5, and with the addition of the use of a prior RIS state. Based on configuration, activation, triggering, etc., the RIS may apply a RIS state(s) for a RIS CSI without the inclusion of a prior RIS state, e.g., as described herein. The RIS may include a prior RIS state in the RIS state(s) used for RIS CSI, e.g., as described herein. The prior RIS state may be the latest received RIS state corresponding to an ID, e.g., a RIS state ID, profile ID, WTRU ID, or other applicable ID.

Features described herein may be associated with a two-level RIS CSI procedure. As discussed herein, a RIS CSI based on an ideal prior RIS state may correspond to a recommended RIS state with factors equal to 1, e.g., with zero phase shift and/or zero amplitude shift/change. The correspondence to a recommended RIS state with factors equal to 1 may be the result of the prior RIS state being included in the effective channel estimated by the WTRU. With a prior RIS state close to the ideal prior RIS state, the RIS state (e.g., recommended RIS state) may correspond to factors close to 1 and phase shifts close to zero. Based on this premise, a two-level CSI procedure may be devised.

In the level 1 CSI procedure, a prior RIS state may not be included during the pilots used for a RIS CSI. The RIS CSI reporting may support reporting of a wide range of (e.g., RIS element or sub-surface) factors, e.g., phase shifts, for example, with the same granularity or quantization.

In the level 2 CSI procedure, a prior RIS state may be included during the pilots (e.g., the symbols) used for RIS CSI. The RIS CSI reporting may support reporting of a range (e.g., limited range) of factors, for example, with finer granularity around factor values near 1 or phase shifts near 0.

The level 2 CSI procedure may work if the prior RIS state is not far (e.g., too far) from an (e.g., ideal or optimal) RIS state. It may be beneficial to operate the level 2 procedure on a time scale (e.g., a small enough time scale) such that fading and other effects change the optimal RIS state (e.g., by a just little), e.g., within the channel coherence time.

The RIS state may be updated based on WTRU reporting from the level 2 CSI procedure. The prior RIS state for the next round of level 2 CSI may be adjusted. The level 2 CSI procedure may support the tracking of changes in the radio channels, etc., overtime, by iteratively measuring (e.g., the WTRU iteratively measuring), reporting (e.g., the WTRU reporting (e.g., recommending)) and applying (e.g., the BS/RIS applying) adjustments (e.g., small adjustments) to the RIS state.

A level 2 CSI procedure may need to be combined with a level 1 CSI procedure that may provide a starting point (e.g., a good starting point) for level 2 CSI adjustments. The level 1 CSI procedure, which may be more costly in terms of signaling and pilot overhead, may find a new suitable RIS state that is different (e.g., significantly different) from a prior RIS state and potentially with higher accuracy. A level 1 CSI procedure may support the assessment of mode of operation, e.g., reflection, refraction, focusing, collimation, modulation, or a combination of these. A level 2 CSI procedure may be such that it measures and reports changes (e.g., smaller changes) to the RIS state, compared to the prior, and for example, within a mode of operation.

A two-level CSI procedure may operate with level 1 CSI and level 2 CSI (e.g., both level 1 CSI and level 2 CSI). The level 1 procedure may include CSI measurement and reporting less frequently, but potentially with more pilots and/or reporting bits. The level 2 procedure may include CSI measurement and reporting more frequently, with potentially fewer pilots and/or reporting bits. Fewer pilots may be achieved by using fewer sub-surfaces during level 2 CSI acquisition, for example, two or four sub-surfaces.

A first round of level 2 CSI may use a recommended RIS state from a previous round of a level 1 CSI as a prior RIS state. A second round of level 2 CSI may use, as a prior RIS state, a RIS state from the first round of level 2 CSI.

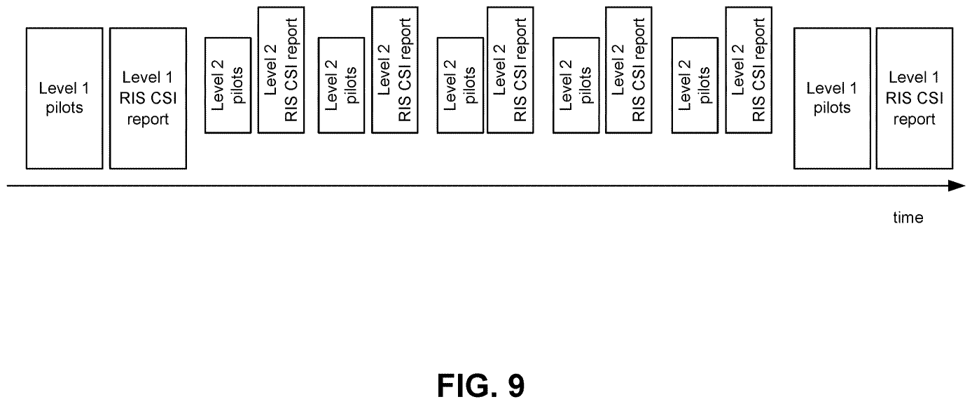

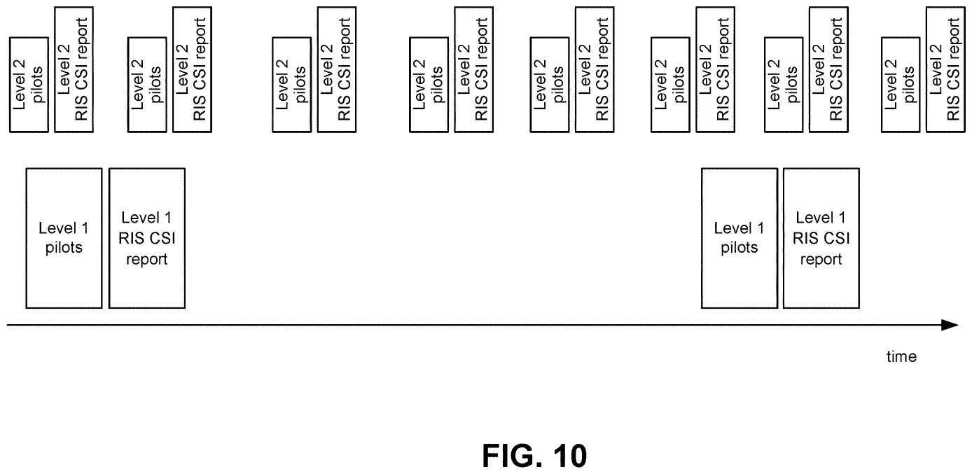

FIG. 9 and FIG. 10 illustrate pilots (e.g., transmitted by BS) and reporting (e.g., by WTRU) in a two-level CSI procedure. The level 1 CSI procedure may operate on a large (e.g., larger) time scale, e.g., with a long (e.g., longer periodicity), while the level 2 procedure may operate on a small (e.g., smaller) time scale, (e.g., with a shorter periodicity). The RIS state may be changed upon a RIS CSI report.

FIG. 9 illustrates that the level 2 CSI pilots and reporting may occur between level 1 pilots and reporting, e.g., such that a RIS CSI report may be transmitted periodically, but the RIS CSI may be either level 1 or 2.

FIG. 10 illustrates that the level 1 CSI procedure (including pilots and reporting) may operate with one (e.g., longer) periodicity and the level 2 CSI procedure (including pilots and reporting) may operate with a (e.g., shorter) periodicity. From a WTRU perspective, the level 1 RIS CSI and level 2 RIS CSI procedures may operate independently. From the BS and RIS perspective, a recommended RIS state in the level 1 RIS CSI report may be used by the RIS (e.g., as a prior RIS state) during level 2 pilots after the reception of the level 1 RIS CSI report. The BS may indicate to the RIS a IRIS state based on a recommended RIS state in a level 1 RIS CSI report, e.g., as the 2nd IRIS state indication discussed herein.

The scheme in FIG. 9 may provide low (e.g., slightly less) overhead, since level 2 pilots and corresponding reporting is omitted in relation with a round of level 1 pilots and reporting. It may be simple (e.g., simpler) to configure and specify the scheme in FIG. 10 since level 1 and level 2 may be configured separately with separate periodicities etc. The RIS CSI measurement and reporting latency may be longer for level 1 RIS CSI than for level 2, for example, due to a larger number of pilots for level 1. This may result in a variable delay between pilots and RIS CSI report in FIG. 9, while the delay between level 2 pilots and corresponding level 2 IRIS CSI report may be constant in FIG. 10.

An example WTRU procedure (e.g., an example high-level WTRU procedure) may be discussed herein. The level 1 CSI procedure may follow pilot transmission/reception, channel estimation, CSI measurement, reporting etc., as described herein, or by other known methods.

The level 2 CSI procedure may follow pilot transmission/reception, channel estimation, CSI measurement, reporting, etc., as described herein, or by other known methods.

Features described herein may be associated with level 1 CSI pilots and channel estimation. From the WTRU perspective, the level 1 procedure may involve receiving one or more, e.g., S1+1, pilots and estimating one or more, e.g., S1+1, channels, which may include a direct channel and one or more RIS-aided cascaded channels. Since different RIS states may be applied during the different pilots, they may typically be time-multiplexed.

For channel estimation, the WTRU may assume that a first set of RIS states was used during the pilots, for example, a RIS estimation matrix W, that may follow a definition for Equation 4 or Equation 8. For example, the WTRU may multiply a received signal vector with (Θ^{s}^{₁})⁻¹ (e.g., for least-squares estimation) or another function of the IRIS estimation matrix Θ^{s}^{₁} (e.g., for minimum mean-square error estimation).

Features described herein may be associated with level 2 CSI Pilots and channel estimation. From the WTRU perspective, the level 2 procedure may involve receiving one or more, e.g., S2+1, pilots and estimating one or more, e.g., S2+1, cascaded channels, which may include a direct channel and one or more RIS-aided cascaded channels. Typically, S2<S1.

For channel estimation, the WTRU may assume that a second set of RIS states was used during the pilots, for example, a RIS estimation matrix Θ^{s}^{₂} that may follow a definition for Equation 4 or Equation 8 (e.g., the first RIS CSI may be based on a first RIS estimation matrix; a second RIS CSI may be based on a second RIS estimation matrix). For example, the WTRU may multiply a received signal vector with (Θ^{s}^{₂}=)⁻¹ (e.g., for least-squares estimation) or another function of Θ^{s}^{₂} (e.g., for minimum mean-square error estimation) in determining a RIS CSI (e.g., one or more of the first RIS CSI or the second RIS CSI).

Features described herein may be associated with level 1 CSI reporting. The WTRU may determine a recommended RIS state based on the estimated channels. The channels may be estimated based on a RIS CSI estimation matrix). In examples, a recommended RIS state Φ may include a RIS state vector of length S1. In examples, a recommended RIS state may include S1 phase shifts without corresponding amplitudes.

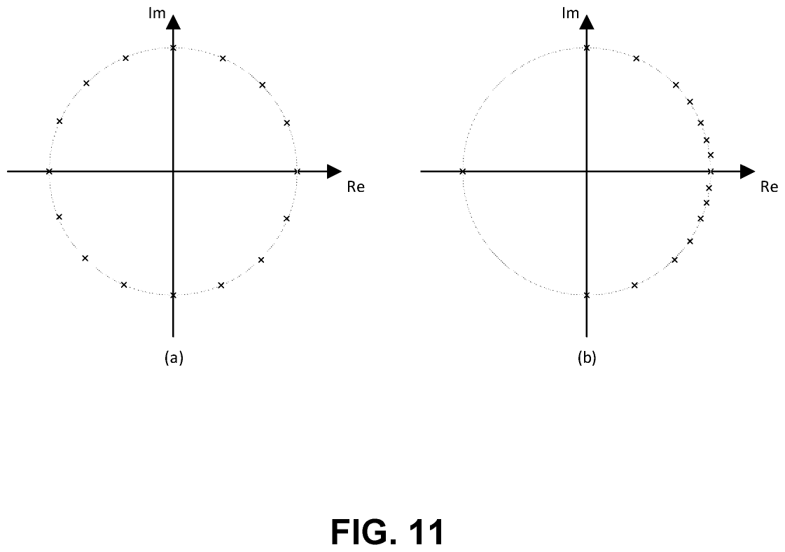

FIG. 11 illustrates an example uniform and non-uniform phase shift quantization. A level 1 RIS CSI report may include a reporting of phase(s) shifts corresponding to the recommended RIS state. The phase shifts may be quantized, for example, using encoding similar to N-PSK. Given that prior phase shift information may not be available, phase shifts between −π and π may be expected with uniform probability distribution. A uniform N-PSK quantization may be suitable for the level 1 CSI reporting, as illustrated in FIG. 11(a) with N=16 (e.g., that can be represented by 4 bits). The x's may represent quantized phase shift values.

A level 1 RIS CSI report may include reporting of amplitudes corresponding to the recommended RIS state. Given that prior amplitude information may not be available, a uniform quantization between a minimum and maximum quantization value may be suitable. In examples, amplitude values may not be explicitly reported. An order of the RIS amplitudes, e.g., the S1 amplitudes, may be reported. In examples, the indices of the terms in the recommended RIS state with highest amplitudes may be reported.

Features described herein may be associated with level 2 CSI reporting. The WTRU may determine a recommended RIS state based on the estimated channels (e.g., the RIS CSI, such as a level 2 RIS CSI may be based on a RIS CSI estimation matrix, such as a second RIS CSI estimation matrix). In examples, a recommended RIS state Φ may include a RIS state vector of length S2. In examples, a recommended RIS state may include S2 phase shifts without corresponding amplitudes.

A level 2 RIS CSI report may include reporting of phase(s) shifts corresponding to the recommended RIS state. The phase shifts may be quantized. Given that the effective channel may include the effect of a prior RIS state, e.g., including prior phase shift information, phase shifts around 0 may be more likely. A non-uniform N-PSK quantization may be suitable for the level 2 RIS CSI reporting. In examples, the x's in FIG. 11(b) may illustrate a non-uniform phase quantization, with higher resolution around phases around 0 and lower resolution for phases closer to π. In examples, the level 2 RIS CSI phase quantization may be uniform within a certain range, e.g. [−a, a].

In example, phase-shifts quantization in a level 2 RIS CSI may correspond to fewer bits than in a level 1 RIS CSI. Phase-shift quantization in a level 2 RIS CSI may be suitable for example, if a level 2 RIS CSI is reported more frequently than a level 1 RIS CSI. In examples, the phase-shift resolution in level 1 and level 2 RIS CSI reports is the same or similar. The phase-shift resolution in level 1 RIS CSI reports and level 2 RIS CSI reports being the same or similar may occur (e.g., may be reasonable) if the RIS hardware supports a range (e.g., a limited range) or a single phase-shift resolution. The quantization scheme of the phase shifts on level 1 and level 2 may be separately or jointly configured by the BS. In examples, the phase shift quantization in level 1 RIS CSI may be the same as the phase shift resolution offered by the RIS hardware. In examples, the phase shift quantization in a level 2 RIS CSI may be the same as in a level 1 RIS CSI (e.g., with a range, such as a limited range). For example, a level 1 RIS CSI may offer phase shift quantization with a resolution (e.g., a certain resolution) between −π and π, and a level 2 RIS CSI may offer a phase shift quantization with a resolution (e.g., the same resolution) between −a and a, where a is a positive number smaller than r. In a numerical example, level 1 RIS CSI phase shifts may be quantized according to uniform 64-PSK using 6 bits, e.g., with a phase resolution of π/32, and level 2 RIS CSI phase shifts may be quantized with the same resolution and may be limited to the four points in the range between 2*(−π/32)=−π/16 and 2*(π/32)=π/16 using 2 bits. The same phase resolution may be used in level 1 and level 2 phase reporting (e.g., since resulting phase shifts after level 1 RIS CSI and level 2 RIS CSI phase adjustments may fall on the same phase shift grid, e.g., on the 64-PSK grid in the numerical example).

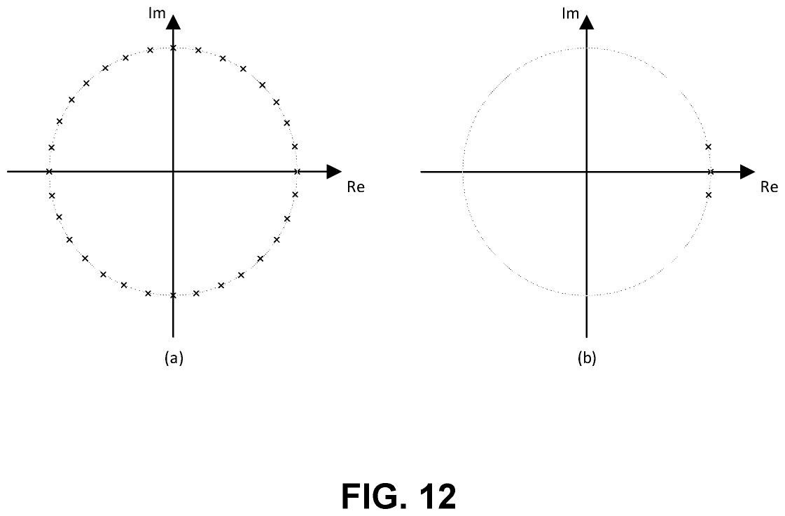

FIG. 12 illustrates an example of uniform and non-uniform phase shift quantization. In examples, an odd number of quantization points may be used for the phase shifts, e.g., if 0 is included as a phase shift value together with ±a, ±b, etc. This is illustrated in FIG. 12 with uniform 32-point quantization in (a) and non-inform 3-point quantization in (b). In examples, an even number of quantization points may be used for the phase shifts, e.g., ±a, ±b, etc.

For level 2 RIS CSI amplitude reporting, non-uniform amplitude quantization with a highest resolution centered around 1 may be suitable, since a RIS factor amplitude changes may (e.g., may typically) be slow.

RIS state amplitude reporting may be omitted in the level 2 RIS CSI procedure while, for example, keeping the RIS state amplitude reporting in the level 1 procedure. In examples, both level 1 and level 2 RIS CSI procedures may include (e.g., only include) phase reporting.

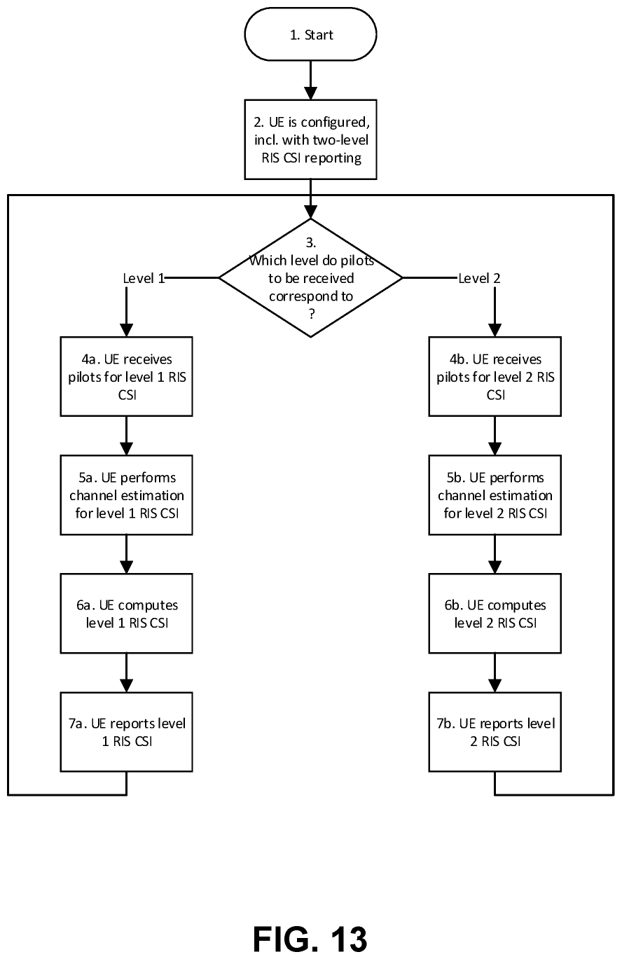

FIG. 13 illustrates an example WTRU procedure, where one or more of the illustrated actions may be performed. At 2, a WTRU may be configured for (e.g., the WTRU may receive configuration information indicating/enabling reporting for) a RIS CSI, e.g., which may be two-level RIS CSI as described herein. The configuration may include resources (e.g., pilots), such as symbols, sub-carriers, sequence, etc., for a RIS CSI measurement, e.g., a CSI-RS. The CSI resource (e.g., pilot) configuration for level 1 CSI and level 2 CSI may be separate. For example, level 1 CSI may correspond to a first resource set (e.g., CSI-RS resource set), and level 2 may correspond to a second resource set. The pilots for level 1 CSI may aperiodic, semi-persistent, or periodic. The pilots for level 2 CSI may aperiodic, semi-persistent, or periodic. In examples, the pilots for level 1 CSI may be aperiodic, while the pilots for level 2 CSI are semi-persistent. In examples, the pilots for level 1 CSI may be aperiodic, while the pilots for level 2 CSI are periodic. In examples, the pilots for level 1 CSI and level 2 CSI may belong to the same resource set and may be aperiodic, semi-persistent, or periodic.

The configuration may include one or more reporting configurations. For example, level 1 RIS CSI reporting may be configured in a first RIS CSI reporting configuration, and level 2 RIS CSI reporting may be configured in a second RIS CSI reporting configuration. In examples, level 1 IRIS CSI reporting and level 2 IRIS CSI reporting may be configured in the same IRIS CSI reporting configuration. The RIS CSI reporting configuration for level 1 RIS CSI reporting may be associated with a resource configuration corresponding to pilots (e.g., symbols) for a level 1 RIS CSI. The CSI reporting configuration for level 2 CSI reporting may be associated with a resource configuration corresponding to pilots (e.g., symbols) for a level 2 RIS CSI.

At 3, the WTRU may receive pilots for RIS CSI. The WTRU may determine if the pilots correspond to level 1 or level 2 RIS CSI.

The WTRU may determine if the pilots correspond to level 1 or level 2 IRIS CSI based on the configuration information received at 2, e.g., based on the resource configuration corresponding to the pilots or based on a IRIS CSI reporting configuration that may be associated with the pilots (or the corresponding resource configuration).

The WTRU may make the determination based on dynamic signaling (e.g., the WTRU may receive configuration information via the dynamic signaling). In examples, control channel signaling (e.g., a DCI in a PDCCH, which may include one or more of a first set of trigger values or a second set of trigger values) that triggered the pilots (e.g., aperiodic pilots) or the RIS CSI report (e.g., aperiodic CSI report) may indicate a level 1 IRIS CSI or a level 2 IRIS CSI. For example, a field in the control channel (e.g., configuration information) may indicate a level 1 IRIS CSI or a level 2 IRIS CSI. In examples, the first set of trigger values (e.g., CSI request values) may correspond to level 1 (e.g., determination of the first IRIS CSI may be based on one or more of the first set of trigger values being satisfied) and the second of trigger values may correspond to level 2 (e.g., determination of the second IRIS CSI may be based on one or more of the second set of trigger values being satisfied). The level associated with a certain trigger value may be configurable.

If the pilots correspond to a level 1 IRIS CSI, the procedure may proceed to 4a. If the pilots correspond to a level 2 IRIS CSI, the procedure may proceed to step 4b.

At 4a, the WTRU may receive the pilots (e.g., CSI-RS) for level 1 RIS CSI, e.g., S1+1 pilots.

At 4b, the WTRU may receive the pilots (e.g., CSI-RS) for level 2 RIS CSI, e.g., S2+1 pilots.

At 5a, the WTRU may estimate channels for a level 1 RIS CSI (e.g., a first RIS CSI), e.g., as discussed in examples herein (e.g., based on a first RIS CSI estimation matrix).

At 5b, the WTRU may estimate channels for level 2 RIS CSI (e.g., a second RIS CSI), e.g., as discussed in examples herein (e.g., based on a second RIS CSI estimation matrix).

At 6a, the WTRU may compute (e.g., determine) a level 1 RIS CSI (e.g., a first RIS CSI), e.g., as discussed in examples herein (e.g., based on a first set of symbols, the first RIS CSI estimation matrix, and a first RIS CSI quantization format).

At 6b, the WTRU may compute (e.g., determine) level 2 RIS CSI (e.g., a second RIS CSI), e.g., as discussed in examples herein (e.g., based on a second set of symbols, the second RIS CSI estimation matrix, and a second RIS CSI quantization format).

At 7a, the WTRU may, e.g., as described herein, report the level 1 RIS CSI (e.g., transmit an indication of the first RIS CSI to the network, for example to a base station). The level 1 RIS CSI may be reported in a PUSCH, e.g., if the payload is large and/or if the reporting is aperiodic. For example, an uplink control information (UCI) carrying the RIS CSI may be multiplexed in a PUSCH. In examples, a MAC CE carrying the RIS CSI may be used, e.g., multiplexed in a PUSCH.

For example, the level 1 RIS CSI may include one more of the following parameters: a set of phase shifts, e.g., 81 phase shifts, according to the phase shift quantization format for level 1 RIS CSI, e.g., that may correspond to a recommended RIS state; a set of amplitude values, e.g., S1 amplitude values, according to the amplitude quantization format for a level 1 RIS CSI, e.g., that may correspond to a recommended RIS state; an RSRP value, e.g., that may be estimated or computed based on an assumption that the set of phase shifts and/or amplitudes are applied; an SINR value, e.g., that may be estimated or computed based on an assumption that the set of phase shifts and/or amplitudes are applied; or a CQI, e.g., that may be estimated or computed based on an assumption that the set of phase shifts and/or amplitudes are applied.

A level 1 RIS CSI may include (e.g., may include only) S1 phase shifts. A level 1 RIS CSI may include S1 phase shifts and an RSRP value. A level 1 RIS CSI may include S1 phase shifts and an SINR value. A level 1 RIS CSI may include S1 phase shifts and a CQI.

At 7b, the WTRU may, e.g., as described herein, report the level 2 RIS CSI (e.g., transmit an indication of the second RIS CSI to the network, for example to a base station). A level 2 RIS CSI may be reported in a UCI in a PUCCH, e.g., if the payload is small and/or if the reporting is periodic and frequent.

For example, the level 2 RIS CSI may include one more of the following parameters: a set of phase shifts, e.g., S2 phase shifts, according to the phase shift quantization format for the level 2 RIS CSI (which may be the same as or different than the quantization format for a level 1 RIS CSI, e.g., as discussed herein), e.g., that may correspond to a recommended RIS state; a set of amplitude values, e.g., S2 amplitude values, according to the amplitude quantization format for the level 2 RIS CSI, e.g., that may correspond to a recommended RIS state; an RSRP value, e.g., that may be estimated or computed based on an assumption that the set of phase shifts and/or amplitudes are applied; an SINR value, e.g., that may be estimated or computed based on an assumption that the set of phase shifts and/or amplitudes are applied; and/or a CCI, e.g., that may be estimated or computed based on an assumption that the set of phase shifts and/or amplitudes are applied.

A level 2 RIS CSI may include (e.g., may include only) S2 phase shifts. A level 2 RIS CSI may include S2 phase shifts and an RSRP value. A level 2 RIS CSI may include S2 phase shifts and an SINR value. A level 2 RIS CSI may include S2 phase shifts and a CQI.

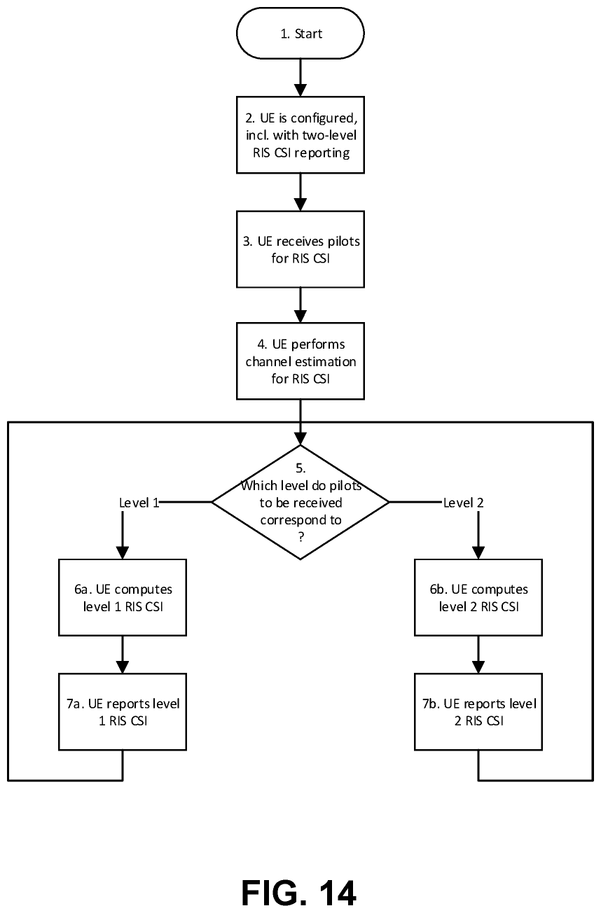

FIG. 14 illustrates an example of a WTRU procedure, where one or more of the illustrated actions may be performed. Compared to FIG. 13, the level 1/level 2 branches may apply to RIS CSI computation and reporting. The RIS CSI pilot reception (e.g., at 3) and corresponding channel estimation (e.g., at 4) may follow the same procedure for level 1 and level 2 RIS CSI. For example, a WTRU may apply different quantization methods in level 1 and level 2 RIS CSI computation (e.g., at 6a and at 6b, respectively). Level 1 and level 2 reporting may differ, e.g., in terms of number of bits.

An example high-level RIS procedure may be presented herein. The indication of RIS state(s) from the BS to the RIS may be considered herein. The indication may be explicit in that the indication may include RIS element factors, sub-surface factors, etc., for example, in terms of factor/sub-surface phase shifts and/or amplitudes. Phase shift and/or amplitude signaling, and representation methods as described for WTRU RIS CSI reporting, e.g., N-PSK, may be used for the BS to RIS indication.

The RIS state indication may indicate a RIS state index from a set of RIS states, which may be pre-defined, configured, and/or based on a reported RIS capability. For example, the set of RIS states may be in the form of a codebook, in which different columns may correspond to different RIS states. For example, an element of the column may be a complex number corresponding to a RIS element or sub-surface factor. A RIS state indication may indicate a column index of a codebook.

In a two-level RIS CSI procedure, the BS may receive a level 1 RIS CSI report from the WTRU with more information, e.g., higher accuracy, wider value ranges, etc., than in a level 2 RIS CSI report. Upon a level 1 RIS CSI report from a WTRU, the BS may need to provide a RIS state indication with information (e.g., more information) to the RIS, e.g., a level 1 RIS state indication. Upon a level 2 RIS CSI report from a WTRU, the BS may provide a RIS state indication with less information to the RIS, e.g., a level 2 RIS state indication. For example, the BS may provide an incremental or differential RIS state indication to the RIS upon a level 2 RIS CSI report from a WTRU. The incremental or differential RIS state indication may provide a RIS state adjustment compared to a previously indicated RIS state corresponding to the WTRU/profile. In examples. with multiple consecutive level 2 RIS CSI reports from a WTRU, the BS may provide multiple consecutive incremental or differential RIS state indications for the WTRU to the RIS. A RIS state to be applied during, for example, data transmissions to/from a WTRU may be the result of a level 1 RIS state indication and one or more level 2 RIS state indications that may have adjusted the level 1 RIS state indication. For example, the RIS may be configured with a level 1 RIS state codebook and a level 2 RIS state adjustment codebook. A level 1 RIS state indication may include an index in a level 1 RIS state codebook, and a level 2 RIS state indication may include an index in a level 2 RIS state adjustment codebook.

A RIS state indicated to the RIS may be associated with a WTRU (e.g., a certain WTRU) or a profile, e.g., in the form of a WTRU ID or a profile ID. The ID may be used (e.g., may be used later) to dynamically schedule/trigger/activate the use of the indicated RIS state, e.g., during subsequent data, control, or RS transmissions. Using the ID to dynamically schedule/trigger/activate the use of the indicated RIS state may keep overhead down if the WTRU/profile ID may be represented by fewer bits than a RIS state.

The RIS may apply a first set of RIS states during pilots for level 1 RIS CSI acquisition. For example, the RIS may apply RIS states according to a RIS estimation matrix, such as Θ or Θ^{s}, as discussed herein. The RIS states in the first set of RIS states may not include a prior RIS state that may be applicable to a certain WTRU (or profile). It may be possible for multiple WTRUs to acquire a RIS CSI based on the same pilots in a level 1 RIS CSI acquisition. Therefore, the level 1 procedure may not be associated with a certain WTRU or a profile. The level 1 procedure may be common or cell specific.

During the pilots for a level 2 RIS CSI, the RIS may apply RIS states that include a prior RIS state, e.g., as described herein. The prior RIS state may be a RIS state for a certain WTRU (or profile). The pilots (e.g., symbols) for a level 2 RIS CSI may be useful (e.g., may be useful only) for the WTRU.

A level 2 procedure at the RIS may be associated with a certain WTRU (e.g., WTRU ID) or a certain profile (e.g., profile ID). For example, the time-domain configuration corresponding to the time-domain symbols (e.g., OFDM or single-carrier FDMA symbols) carrying the level 2 pilots may be associated with the WTRU or the profile. By the association between a level 2 RIS CSI procedure and WTRU/profile, signaling of the prior RIS state to use may be avoided. The last indicated RIS state associated with the WTRU or profile may act as the prior RIS state in the corresponding level 2 procedure. There may be a certain delay (e.g., a certain minimum delay) between the reception of a RIS state indication and its use as a prior RIS state in a level 2 RIS CSI procedure.

With a WTRU specific level 2 RIS CSI procedure and multiple WTRUs served by a RIS, the RIS may operate level 2 RIS CSI procedures (e.g., multiple level 2 RIS CSI procedures) in parallel. For example, there may be multiple prior RIS states stored at the RIS (or RIS controller) at the same time, e.g., a prior RIS state per WTRU. Therefore, there may be as many sets (e.g., as many different sets) of RIS states (e.g., to be applied during pilots for level 2 RIS CSI) stored at the RIS (or RIS controller) as WTRUs served by the RIS. As the RIS receives an indication of a new RIS state corresponding to a WTRU, the RIS may update its prior RIS state for the WTRU. Upon a RIS state indication for a WTRU, the RIS may update the set of RIS states that includes the prior RIS state and the RIS states that are to be used during pilots for a level 2 RIS CSI procedure for the WTRU. Alternatively, the RIS may update the set of RIS states just before BS transmission of pilots for level 2 RIS CSI procedure for a WTRU based on the latest received RIS state indication for the WTRU.

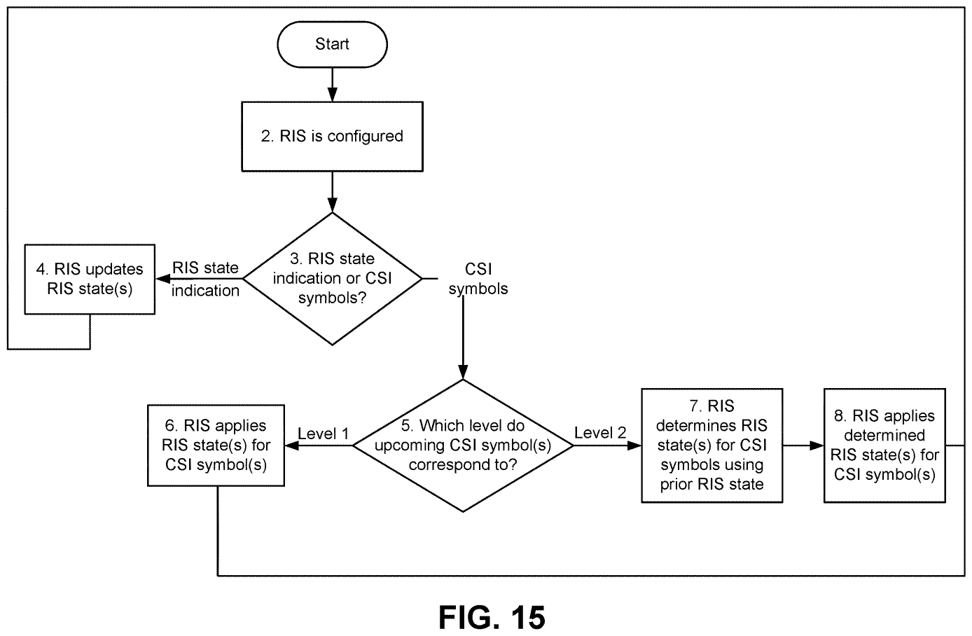

FIG. 15 illustrates an example RIS procedure, where one or more of the illustrated actions may be performed. A RIS may be configured by the BS, e.g., as shown at 2. The configuration may, for example, include various configurations as discussed herein.

At 3, the RIS may determine if indication(s) of one or more RIS state(s) have been received from a BS or if CSI symbols are upcoming. CSI symbols may be symbols that carry pilots for a RIS CSI procedure, e.g., level 1 RIS CSI or level 2 RIS CSI.

If indication(s) of one or more IRIS state(s), e.g., for one or more WTRUs, have been received at 4, the RIS (or RIS controller) may update the stored RIS states, e.g., the RIS states for the WTRUs. A RIS state indication may indicate a WTRU or profile ID.

At 5, if CSI symbols are upcoming, the RIS (or RIS controller) may determine which RIS CSI procedure level the CSI symbols correspond to.

If level 1, at 6, the RIS (or RIS controller) may apply the set of RIS state(s) applicable to a level 1 RIS CSI procedure.

If level 2, at 7, the RIS (or RIS controller) may determine the set of RIS state(s) applicable to a level 2 RIS CSI procedure. For example, the level 2 RIS CSI procedure may correspond to a particular WTRU or profile. The RIS may determine which WTRU/profile that the level 2 RIS CSI procedure corresponds to and may determine the set of RIS states to use during CSI symbols. The set of RIS states may be determined by determining the prior RIS state corresponding to the WTRU/profile, e.g., the latest received/indicated and applicable RIS state corresponding to the WTRU/profile, and determining the set of RIS states to use during the CSI symbols by basing the set of RIS states on the prior IRIS state, e.g., by multiplying the prior IRIS state with a set of RIS states, e.g., the set of RIS states used in a level 1 RIS CSI, such as in a IRIS estimation matrix or according to other examples described herein.

In cases, the RIS may use a previous RIS state (e.g., multiple previous RIS states) corresponding to the WTRU/profile to determine the set of RIS states to use during the CSI symbols. For example, the RIS may use multiple previous RIS states to estimate a RIS state change gradient and to determine the prior IRIS state (e.g., to be used, for example, as described herein) based on the previous RIS states and the gradient, e.g., by extrapolation from the latest received/indicated and applicable RIS state.

At 8, the RIS may apply the determined set of RIS states during the CSI symbols.

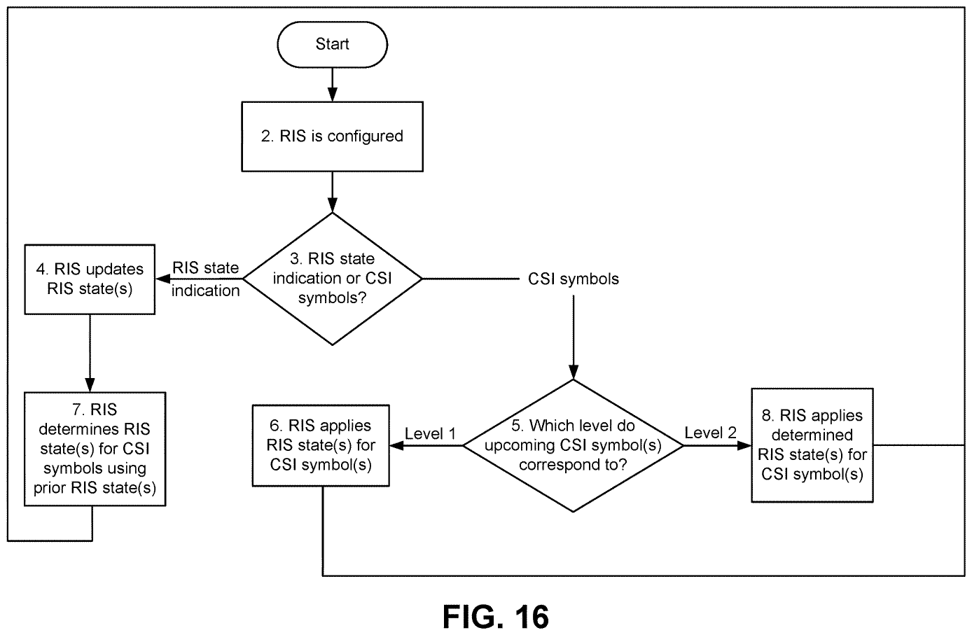

FIG. 16 illustrates an example RIS procedure (e.g., where one or more of the illustrated actions may be performed) that may be a variation of the procedure illustrated in FIG. 15. A difference is that 7 may be performed upon reception of a RIS state indication, which may result in the update of a RIS state for a WTRU/profile. In examples, the set of RIS states to use during CSI symbols for a level 2 RIS CSI procedure for the WTRU may be updated upon update of the RIS state that serves as prior RIS state.

In FIG. 16 less processing may be needed between the determination of upcoming CSI symbol(s) and the application of RIS state(s), which, for example, may help reduce latency for aperiodic triggering of level 2 RIS CSI measurement and reporting. A disadvantage may be that step 7 may be performed multiple times before step 8, e.g., if the RIS state of a WTRU is updated twice between two occasions of CSI symbols for level 2 RIS CSI, which may result in unnecessary computations.

RIS CSI Reports and indications may be based on RIS State Spaces. A RIS state space may include a set of RIS states. The set of RIS states (or a corresponding RIS state space) may be denoted [symbol] . Each RIS state in [symbol] may be identified by an index, e.g. k=1, 2, . . . , F, with F denoting the number of states in the set. Here, k may denote an identifier in a RIS state space. For example, [symbol] {Φₖ} with k=1, . . . , F.

In examples, a RIS state space may include RIS states that can be reported by a WTRU to the BS, e.g., following a DL reference signal measurement as described herein. A RIS CSI report transmitted by a WTRU to a BS may include one or more identifier(s) of RIS state(s) in an RIS state space, e.g., by one or more indices k. The RIS state(s) reported in a RIS CSI report may be selected based on various criteria. For example, a RIS state estimated to maximize the received power at the WTRU may be selected to be reported. Instead of recommending a RIS state by reporting (e.g., explicitly reporting) a RIS element or RIS sub-surface factors

$$( e . g . , {ϕ}_{m} or {ϕ}_{j}^{s} ) ,$$

the WTRU may recommend a RIS state (e.g., by reporting a RIS state ID in a RIS state space).

The WTRU recommendation of a RIS state via a report of a RIS state ID in a RIS state space may require that the applicable RIS state space (e.g., RIS states and corresponding IDs) is known by both the WTRU and the ES. The ES may indicate or configure a WTRU with one or more RIS state spaces, [symbol] ₙ, with n corresponding to a RIS state space ID. RIS state spaces may also be specified or pre-configured. The WTRU may provide additional assistance information to aid RIS state space configuration. In examples, the WTRU may provide its mobility-state, e.g., high-mobility, medium-mobility, low-mobility, or other ways of quantization of mobility info based on translational motion. The mobility-state may be related to rotational motion or orientation info in addition to or in lieu of translational motion.

If a WTRU is configured with one or more RSI state spaces, the WTRU may receive such a configuration through RRC signaling including dedicated RRC signaling or common RRC signaling (e.g., through a system information broadcast). The RRC signaling may carry one or more RIS state spaces IDs or hierarchy thereof (e.g., as described herein) of the one or more RIS state spaces being configured into the WTRU and corresponding CSI reporting configuration (e.g., as described herein). Additionally, for a RIS state space configured into the WTRU, the RRC signaling may carry one or more RIS state IDs of the one or more RIS states that belongs to the RIS state space. An operational state in the form of an active state or an inactive state may be specified for a RIS state space. An operational active state for a RIS state space may mean that the WTRU can use the RIS state space, while an inactive RIS state space may mean that the WTRU cannot use the RIS state space if this RIS state space is configured into the WTRU. When the WTRU is configured with a RIS state space, the RIS state space may be configured with an initial operational active state or operational inactive state. The WTRU may receive from the scheduler for, e.g., the base station, a command that activates a RIS state space that is in an operational inactive state. The WTRU may receive such a command in the form of a MAC Control Element (MAC CE) or in the form of a Downlink Control Information (DCI). The MAC CE or the DCI may carry one or more RIS state spaces IDs of the one or more RIS state spaces IDs being activated into the WTRU. When the WTRU receives an activation command for a RIS state space, the WTRU may activate the operational state of the RIS state space from inactive state to active state, i.e., the WTRU may change the operational state of the RSI state space to active state as per the received activation command. A RIS state space may include RIS states in either an operational active state or an operational inactive state. A RIS state space which is in active state may include one or more RIS states in either an active state or an inactive state. An operational state of a RIS state, in the form of an active state or an inactive state, may be specified for a RIS state. An operational active state for a RIS state may mean that the WTRU can use the RIS state, while an inactive RIS state may mean that the WTRU cannot use the RIS state if the RIS state is configured into the WTRU. When the WTRU is configured with a RIS state, the RIS state may be configured with an initial operational active state or operational inactive state. The WTRU may receive from the scheduler for, e.g., the base station, a command that activates a RIS state that is in operational inactive state. The WTRU may receive such a command in the form of a MAC Control Element (MAC CE) or in the form of a Downlink Control Information (DCI). The MAC CE or the DCI may carry one or more RIS state IDs of the one or more RIS states IDs being activated into the WTRU. When the WTRU receives an activation command for a RIS state, the WTRU may activate the operational state of the RIS state from an inactive state to active state, i.e., the WTRU may change the operational state of the RIS state to an active state as per the received activation command.

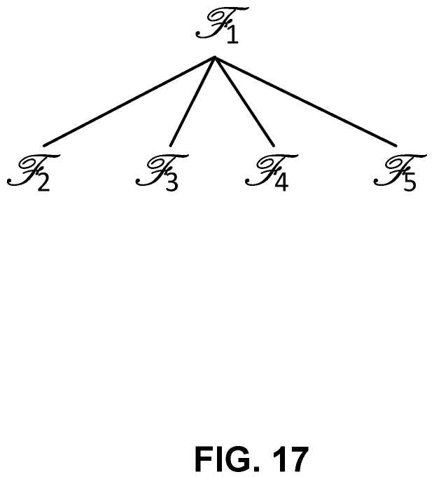

FIG. 17 illustrates an example of a hierarchy of RIS state spaces.

Features described herein may be associated with a hierarchy of RIS state spaces. A RIS state space n₂ may be a sub-space of another RIS state space n₁, e.g., [symbol] ₙ_{₂}⊆ [symbol] ₙ_{₁}. In examples, RIS state spaces may be related in a hierarchical manner, as illustrated in FIG. 17. In FIG. 17, the RIS state space [symbol] ₁ may be above (e.g., above a parent of) the RIS state spaces (e.g., children RIS state spaces) [symbol] ₂ to [symbol] ₅ in the hierarchy. This may mean that [symbol] ₂ to [symbol] ₅ are sub-spaces of [symbol] ₁.

In cases, a second RIS state space that is below a first RIS state space in a hierarchy may not be a sub-space of the first RIS state space. In the example in FIG. 17, [symbol] ₂ to [symbol] ₅ may not be sub-spaces of [symbol] ₁. One or more of the RIS states in the second RIS state space may not be included among the RIS states in the first RIS state space. In cases, one or more (but not all) RIS states in the second RIS state space may be included among the RIS states in the first RIS state space.

The hierarchy may correspond to another property. For example, a RIS state space in a higher level in the hierarchy may include RIS states corresponding to a wider range of reflection angles, phase shifts, and/or channel conditions etc., while a RIS state space below may correspond to a smaller range. A smaller range may correspond to a finer granularity and/or fewer RIS states. For example, using the RIS state spaces in FIG. 17 as an example, [symbol] ₁ may correspond to a range, e.g., of reflection angles. For example, if a RIS state space lower in the hierarchy, e.g., [symbol] ₂ to [symbol] ₅, is a sub-space of [symbol] ₁, the granularity (e.g., the granularity of reflection angles) may be the same, but the range may be small (e.g., smaller). For example, if a RIS state space is low (e.g., lower) in the hierarchy, e.g., if [symbol] ₂ to [symbol] ₅ is not a sub-space of [symbol] ₁, the granularity (e.g., the granularity of reflection angles) may be finer.

In examples, a child RIS state space may be related to the parent RIS state space, such that a RIS state in the parent RIS state space is used as a prior RIS state for the RIS states in the child RIS state space. For example, a RIS state \tilde{Φ} in the child RIS state space may have a RIS state Φ̅ in the parent RIS state space as prior RIS state, e.g., \tilde{Φ}=Φ̅⊙Φ, similarly as described herein. The prior RIS state may or may not be a member of the child RIS state space.

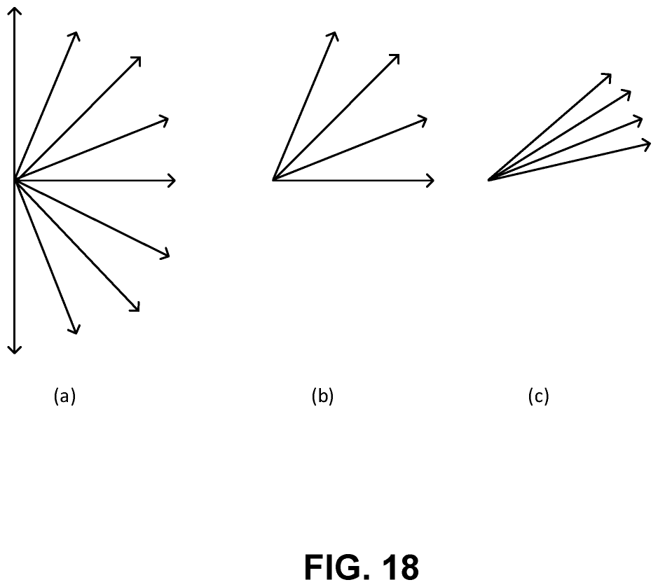

FIG. 18 illustrates an example of a hierarchy of RIS state spaces.

An arrow may represent a RIS state, and the direction of the arrow may represent one or more properties of the RIS state, e.g., reflection angle, reflection focus level, phase shifts, etc. A WTRU with a certain arrow (e.g., a RIS state) may be more likely to move (e.g., subsequently move) to an adjacent arrow (e.g., a RIS state). FIG. 17(a) may illustrate a RIS state space high (e.g., higher) up in the hierarchy, e.g., [symbol] ₁. The RIS states (e.g., arrows) may span a wide range of directions. FIG. 17(b) or FIG. 17(c) may correspond to a RIS state space lower in the hierarchy, e.g., [symbol] ₂. In FIG. 18 (b), the RIS state space may be a subset of the RIS state space in FIG. 18 (a). The RIS states (e.g., arrow) may span a less wide range of directions, and the granularity (e.g., in direction/angle) may be the same. In FIG. 18(c), the RIS state space may not be a subset of the RIS state space in FIG. 18(a). The granularity of the RIS states (e.g., arrow) may be fine (e.g., finer), and the range may be small (e.g., smaller).

The number of configured RIS state spaces configured may depend on the granularity of a RIS element or RIS sub-surface factors

$$( e . g . , {ϕ}_{m} or {ϕ}_{j}^{s} ) .$$

Different levels in a hierarchy of RIS state spaces may correspond to different quantization formats, e.g., for reporting RIS element or sub-surface phase shifts.

Features described herein may be associated with CSI reporting for RIS state spaces. A RIS CSI report by a WTRU may include an indication of a RIS state space, e.g., using the ID n.

In examples, a RIS CSI report may be based on an RIS measurement associated with a first RIS state space. In examples, the first RIS state space may be used during RIS CSI pilots, e.g., the first RIS state space may include the RIS states in Θ or Θ^{s}. In examples, the first RIS state space may not be used (e.g., directly used) during the RIS CSI pilots. The first RIS state space may include RIS states that the WTRU can recommend in the RIS CSI report. In examples, a second RIS state space may be indicated (e.g., explicitly indicated) in the RIS CSI report, e.g., by index n, e.g., together with a recommended RIS state from the first RIS state space, e.g., by index n. In examples, a second RIS state space may be indicated (e.g., explicitly indicated) in the RIS CSI report, e.g., by index n, without a recommended RIS state. The range of the reported index may be limited to the RIS state spaces that are an immediate subset (or as described herein by other association) to the first RIS state space, and reporting bits may be saved. For example, a state space below (e.g., immediately below) another state space may not be a subset. Instead, a hierarchy and an association between a state space and its children state spaces may be based on an aspect (e.g., a range of reflection examples, etc.) In examples, a second RIS state space may be indicated (e.g., may be implicitly indicated) in the RIS CSI report, e.g., via a recommended RIS state from the first RIS state space. In examples, a RIS state in the first RIS state space may be associated with a second RIS state space, e.g., by explicit configuration, or by which RIS state space of the lower hierarchical level the recommended RIS state is part of.

Levels (e.g., different levels) in a hierarchy of RIS state spaces may correspond to RIS CSI procedure levels (e.g., different RIS CSI procedure levels). For example, a first level, e.g., the highest level, in a hierarchy may correspond to a level 1 RIS CSI procedure. A second level, e.g., the second highest level, in a hierarchy may correspond to a level 2 RIS CSI procedure.

During a level 1 RIS CSI procedure, the WTRU may use a RIS state space on the first level for determining a RIS state for RIS CSI reporting. If there are multiple applicable RIS state spaces on the first level, the BS may indicate or configure which RIS state space to use for a particular RIS CSI measurement and reporting occasion. The WTRU may use a RIS state space on the first level that it reported in a previous RIS CSI report.

During a level 2 RIS CSI procedure, the WTRU may use a RIS state space on the second level for determining a RIS state for RIS CSI reporting. If there are multiple applicable RIS state spaces on the second level, the BS may indicate or configure which RIS state space to use for a particular RIS CSI measurement and reporting occasion. Alternatively, the WTRU may use a RIS state space on the second level that it reported in a previous RIS CSI report.

In examples, a RIS state space may include RIS states that can be indicated by a BS to a RIS (or RIS controller). Similar to the WTRU reporting described herein, the BS may indicate a RIS state space for a particular WTRU (or profile) to the RIS, explicitly or implicitly, Indication of a suitable RIS state space to the IRIS may save subsequent signaling overhead if the indicated RIS state space is smaller than the previously used RIS state space. Indication of a suitable RIS state space to the RIS may improve the RIS state accuracy if the RIS state space granularity is fine (e.g., finer).

In examples, a RIS state space may include RIS states that can be reported by a WTRU to the BS and that can be indicated by a BS to a IRIS (or RIS controller).

An example RIS procedure may include one or more of the following. An IRIS controller may receive an indication of a first RIS estimation matrix and a second RIS estimation matrix and a first set of symbols and a second set of symbols. The RIS controller may apply to the RIS a first set of RIS states based on the first RIS estimation matrix (e.g., columns of the first RIS estimation matrix) during a first set of symbols. The RIS controller may receive an indication of a first RIS state for a WTRU. The RIS controller may apply, to the RIS, the first RIS state during a second set of symbols. The RIS controller may determine a second set of RIS states for the WTRU based on the first RIS state and a third set of RIS states based on the second RIS estimation matrix (e.g., the columns of the second RIS estimation matrix). The RIS controller may apply to the RIS the second set of RIS states during a second set of symbols.

An exemplary WTRU procedure may include one or more of the following. A WTRU may receive an indication of a first RIS estimation matrix, a second RIS estimation matrix, a first set of symbols, a second set of symbols, a first CSI quantization format, and a second CSI quantization format. The first CSI quantization format may use a uniform distribution of phase quantization points. The second CSI quantization format may use a non-uniform distribution of phase quantization points, e.g., with a highest density of quantization points around phase zero. The WTRU may receive a first set of symbols. The WTRU may estimate (e.g., determine), based on the first set of symbols, a first RIS CSI based on the first IRIS estimation matrix. The WTRU may quantize (e.g., determine) the first RIS CSI based on a first quantization format. The WTRU may report a quantized first RIS CSI (e.g., the first RIS CSI), for example the WTRU may transmit an indication of the quantized first RIS CSI (e.g., the first RIS CSI based on the first set of symbols, the first RIS CSI estimation matrix, and the first RIS CSI quantization format) to the network, e.g., to a base station. The WTRU may receive a second set of symbols. The WTRU may, based on the second set of symbols, estimate (e.g., determine) a second RIS CSI based on the second RIS estimation matrix. The WTRU may quantize (e.g., determine) the second RIS CSI based on a second quantization format. The WTRU may report a quantized second RIS CSI (e.g., the second RIS CSI), for example the WTRU may transmit an indication of the quantized second RIS CSI (e.g., the second RIS CSI based on the first set of symbols, the first RIS CSI estimation matrix, and the first RIS CSI quantization format) to the network, e.g., to a base station.

Systems, methods, and instrumentalities may be configured for two-level reconfigurable intelligent surface (RIS) channel state information (CSI). A wireless transmit/receive unit may receive a first set of symbols. The WTRU may determine a first RIS CSI based on the first set of symbols, a first RIS CSI estimation matrix, and a first RIS CSI quantization format. The first RIS CSI quantization format may use a uniform distribution of phase quantization points. The WTRU may transmit the first RIS CSI. The WTRU may receive a second set of symbols. The WTRU may determine a second RIS CSI based on the second set of symbols, a second RIS CSI estimation matrix, and a second RIS CSI quantization format. The second RIS CSI quantization format may use a non-uniform distribution of phase quantization points. The WTRU may transmit the second RIS CSI.

The WTRU may receive configuration information. The configuration information may indicate a first set of trigger values. The determination of the first IRIS CSI may be performed based on one or more of the first set of trigger values being satisfied. The configuration information may indicate a second set of trigger values. The determination of the second RIS CSI may be performed based on one or more of the second set of trigger values being satisfied.

The first set of trigger values may be indicated in downlink control information (DCI) in a physical downlink control channel (PDCCH). The second set of trigger values may be indicated in downlink control information (DCI) in a physical downlink control channel (PDCCH). The non-uniform distribution of phase quantization points may include a highest density around a phase zero.

Described herein are systems, methods, and instrumentalities associated with a wireless communication network comprising a reconfigurable intelligent surface (IRIS). Enhancements to WTRUs, the RIS, and/or network devices may be implemented, e.g., to improve the performance of the communication network. The enhancements may be associated with CSI acquisition, CSI-RS provision, RIS configuration, RIS control, CSI feedback or reporting, etc.

A wireless transmit receive unit (WTRU) may include a processor. The WTRU may receive an indication of a first reconfigurable intelligent surface (RIS) estimation matrix, a second RIS estimation matrix, a first set of symbols, a second set of symbols, a first channel state information (CSI) quantization format, and a second CSI quantization format. The WTRU may receive the indicated first set of symbols and estimate a first CSI based on the indicated first RIS estimation matrix, and the first CSI may correspond to the received first set of symbols. The WTRU may quantize the first CSI based on the indicated first quantization format. The WTRU may report the quantized first CSI and receive the indicated second set of symbols. The WTRU may estimate a second CSI based on the indicated second RIS estimation matrix, and the second CSI may correspond to the received second set of symbols. The WTRU may quantize the second CSI based on the indicated second quantization format and report the quantized second CSI.

The first CSI quantization format may use a uniform distribution of phase quantization points, and the second CSI quantization format may use a non-uniform distribution of phase quantization points. The non-uniform distribution of phase quantization points may include a highest density of quantization points around a phase zero.

A device, such as an RIS controller, may include a processor. The device may receive an indication of a first reconfigurable intelligent surface (RIS) estimation matrix, a second RIS estimation matrix, a first set of symbols, and a second set of symbols. The device may apply, to a RIS, a first set of RIS states based on a plurality of columns of the first RIS estimation matrix during the first set of symbols. The device may receive an indication of a first RIS state from the first set of RIS states for a wireless transmit receive unit (WTRU). The device may apply, to the RIS, the first RIS state during the second set of symbols. The device may determine a second set of RIS states for the WTRU based on the first RIS state and a third set of RIS states based on a plurality of columns of the second RIS estimation matrix. The device may apply, to the RIS, the second set of RIS states during the second set of symbols.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-12. (canceled)

13. A wireless transmit/receive unit (WTRU) comprising:
a processor configured to:
receive configuration information, wherein the configuration information indicates at least an association between a first reconfigurable intelligent surface (RIS) state associated with a first set of RIS state spaces and a second RIS state space associated with a second set of RIS state spaces;
receive a first set of symbols;
determine the first RIS state from a first RIS state space of the first set of RIS state spaces, wherein the determination of the first RIS state is based on the first set of symbols and a first RIS estimation matrix;
transmit a first RIS channel state information (CSI) report that indicates the first RIS state;
receive a second set of symbols;
determine, based on the determined first RIS state and the association, the second RIS state space associated with the second set of RIS state spaces;
determine a second RIS state from the determined second RIS state space based on the second set of symbols and a second RIS estimation matrix; and
transmit a second RIS CSI report that indicates the second RIS state.

14. The WTRU of claim 13, wherein the first set of RIS state spaces is a parent set of RIS state spaces, and wherein the second set of RIS state spaces is a child set of RIS state spaces.

15. The WTRU of claim 13, wherein the configuration information further indicates:
the first RIS estimation matrix and a first RIS CSI quantization format;
the second RIS estimation matrix and a second RIS CSI quantization format; and
the first set of RIS state spaces and the second set of RIS state spaces, wherein each of the first set of RIS state spaces comprises a respective first RIS state and each of the second set of RIS state spaces comprises a respective second RIS state.

16. The WTRU of claim 13, wherein the processor is configured to receive, from a base station, an indication of an activation of the first RIS state space of the first set of RIS state spaces, and wherein the first RIS state is determined based on the activation of the first RIS state space.

17. The WTRU of claim 13, wherein the processor is configured to transmit, to a base station, assistance information that indicates a mobility state of the WTRU, wherein the mobility state comprises at least one of a high-mobility, medium-mobility, low-mobility, or an orientation-based mobility condition.

18. The WTRU of claim 13, wherein the first RIS CSI report indicates the first RIS state via a first identifier, and wherein the second RIS CSI report indicates the second RIS state via a second identifier.

19. A method for a wireless transmit/receive unit (WTRU), the method comprising:
receiving configuration information, wherein the configuration information indicates at least an association between a first reconfigurable intelligent surface (RIS) state associated with a first set of RIS state spaces and a second RIS state space associated with a second set of RIS state spaces;
receiving a first set of symbols;
determining the first RIS state from a first RIS state space of the first set of RIS state spaces, wherein the determination of the first RIS state is based on the first set of symbols and a first RIS estimation matrix;
transmitting a first RIS channel state information (CSI) report that indicates the first RIS state;
receiving a second set of symbols;
determining, based on the determined first RIS state and the association, the second RIS state space associated with the second set of RIS state spaces;
determining a second RIS state from the determined second RIS state space based on the second set of symbols and a second RIS estimation matrix; and
transmitting a second RIS CSI report that indicates the second RIS state.

20. The method of claim 19, wherein the first set of RIS state spaces is a parent set of RIS state spaces, and wherein the second set of RIS state spaces is a child set of RIS state spaces.

21. The method of claim 19, wherein the configuration information further indicates:
the first RIS estimation matrix and a first RIS CSI quantization format;
the second RIS estimation matrix and a second RIS CSI quantization format; and
the first set of RIS state spaces and the second set of RIS state spaces, wherein each of the first set of RIS state spaces comprises a respective first RIS state and each of the second set of RIS state spaces comprises a respective second RIS state.

22. The method of claim 19, wherein the method comprises receiving, from a base station, an indication of an activation of the first RIS state space of the first set of RIS state spaces, and wherein the first RIS state is determined based on the activation of the first RIS state space.

23. The method of claim 19, wherein the method comprises transmitting, to a base station, assistance information that indicates a mobility state of the WTRU, wherein the mobility state comprises at least one of a high-mobility, medium-mobility, low-mobility, or an orientation-based mobility condition.

24. The method of claim 19, wherein the first RIS CSI report indicates the first RIS state via a first identifier, and wherein the second RIS CSI report indicates the second RIS state via a second identifier.
